(19) United States
(12) Patent Application Publication
(10) Pub. No.: US 2010/0122685 A1
(43) Pub. Date: May 20, 2010

(54) Spherical two stroke engine system

(75) Inventor: Wieslaw Julian Oledzki, Bialystok (PL)

Correspondence Address: WIESLAW OLEDZKI, UL.NOWY SWIAT 18 M. 21, BIALYSTOK, 15-457, PL

(73) Assignee: WARSAW UNIV. OF LIFE SCIENCES, Warsaw (PL)

(21) Appl. No.: 12/313,312

(22) Filed: Nov. 20, 2008

(51) Int. Cl. F02B 53/00; F02B 75/02; F01C 1/12

(52) U.S. Cl. 123/242; 418/61.1

(57) ABSTRACT

The invention relates to heat engines and more specifically to positive displacement internal combustion engines, and is particularly concerned with rotary and oscillating spherical engines i.e. engines, in which piston executes rotary/oscillating motion and combustion chamber and principal engine's parts that converts gas pressure into rotary movement assume general form of sphere. The invention provides the optimal, “canonical” form for the two stroke rotary and oscillating spherical engine of unique strength and compactness.

### TECHNICAL FIELD OF THE INVENTION

The invention relates to heat engines and more specifically to positive displacement internal combustion engines, and is particularly concerned with rotary and oscillating spherical engines i.e. engines, in which piston executes rotary/oscillating motion and combustion chamber and principal engine's parts that converts gas pressure into rotary movement assume general form of sphere. The invention provides the optimal, “canonical” form for the two stroke rotary and oscillating spherical engine of unique strength and compactness.

### STATE OF THE ART AND BACKGROUND OF THE INVENTION

Existing successful heat engines are steam turbines, gas turbines and positive displacement engines (reciprocating piston and rotary Wankel) utilizing various thermodynamic cycles (Diesel (or rather Sabathe), Otto and Stirling cycle). These engines, although now having been developed for more than century (almost 2 centuries in the case of Stirling), still stop short from fulfilling the requirements imposed on prime movers by modern economy. Thus steam turbines require huge steam boilers and steam condensers and are troublesome to exploit, therefore their applications are restricted to power plants and propulsion of ships and some other heavy machinery. Gas turbines, thermal efficiency of which can achieve even 65% in large units destined for power generation and industrial applications (e.g. in most recent large turbines built by GE, which in fact are compound heat machines with large heat exchanger), usually, particularly in small units, display much poorer figure than positive displacement engines, are more complicated technologically and more expensive, and therefore are unlikely to earn as dominant position as Diesels enjoy today due to these and other well-known inherent drawbacks and limitations. Thus positive displacement engines still have important advantages over turbines that render them irreplaceable for most applications.

Most common positive displacement engine in use (and in fact most common heat engine), Diesel engine, achieves maximum overall efficiency of slightly beyond 50% (large stationary or marine units, which again are compound heat machines comprising Diesel engine, turbocharger, supercharging air cooler and auxiliary power turbine), and average Diesel efficiency is merely ˜40%, a poor figure in comparison with 70-75% originally assumed by its inventor in late 19^{th} century. Thermal efficiency of Diesel cycle rises with the compression ratio, but this method for improving overall efficiency of real Diesel engines is obstructed by friction loses rapidly rising with loads of engine's mechanism. Moreover, conventional connecting rod—crank mechanism's strength becomes a concern in highly loaded Diesel engines.

Another well-known positive displacement heat engine is the (external combustion) Stirling engine. This engine is closest to the ideal Carnot engine in terms of thermal efficiency, and another important advantage over known internal combustion engines is its capability to utilize various sources of thermal energy. However, Stirling engine is expensive to manufacture and troublesome to maintain, and this renders it considerably inferior to internal combustion engine in most applications, and prevents from earning wide acceptance.

There are many non-conventional designs of heat engines (most of them focusing on transforming gas force into driving torque of rotating shaft), e.g. rotary engines like Wankel, recently patented quasi turbine (see U.S. Pat. Nos. 6,164,263 and 6,899,075), spherical engines (see U.S. Pat. Nos. 6,325,038, and 6,941,900, and Russian patent 2,227,211) and oscillating pivotal engine (see www.PivotalEngine.com). However, so far none of those non-conventional engines, with Wankel-type engine being the only exception of economically (but certainly not conceptually) marginal importance, was successful, and probably none of them has any chance to even go beyond the stage of prototyping. Technically, this is due to the fact that the answer to the principal question any new engine is obliged to answer: “Does the new engine do its work better than conventional one?” is decidedly negative for all those non-conventional designs, including Wankel's. Even the answer to the more general question: “Does the new engine do its work in any aspect better than conventional one?” is negative for almost all non-conventional engines. (In the case of the Wankel engine, the answer to this more general question is positive, but superiority of Wankel over conventional engines in certain aspects (great power/weight and power/volume ratios, kinetic simplicity and smoothness of operation) is overshadowed by its inherent drawbacks (weak structure, inability to cope with large outputs, inferior efficiency, weakness of sealing, inherent inability to incorporate high compression ratios)). Conceptually, this is mainly due to the fact that those new engine designs (e.g. quasi turbine) focus on certain isolated aspects of heat engine while ignoring some other aspects (e.g. sealing, mechanical strength and reliability).

For example, recently patented positive displacement rotary engine, quasi-turbine, is complex both kinetically and structurally, its moving elements of complicated shapes are likely to be subjected to excessive thermal stresses and renders the engine weak structurally and more difficult to seal than Wankel engine; thus the engine is unlikely to do well the job of heat engine (it would be better as pump or compressor). Some other rotary engines (e.g. satellite engine, see publication WO9618024) use toothed wheels to transfer the pistons movement to rotary motion of engine's shaft. This not only makes these engines complex but also unreliable, as engine's elements that meet along a line are not well suited to bear shock loads met with in internal combustion engines.

Fuel cell is a very promising source of power for many applications, but it seems improbable it will become appropriate for applications where high power density is essential in any foreseeable future.

Thus there is a need for highly efficient universal source of mechanical power, and highly efficient and clean thermodynamic processes for producing hot high pressure gases, like detonation, compression ignited combustion of homogeneous charge and very high-pressure Sabathe cycle, render positive displacement internal combustion engines a very interesting proposition, provided that efficient way for converting thermal energy into useful mechanical power is incorporated. It is to be stressed that lack of such effective method for converting thermal energy into driving torque is an important obstacle to develop a practical Homogeneous Charge Compression Ignition (HCCI) and Positive Displacement Detonation (PDD) engine. The reason is that maximum gas forces themselves, as well as gradients of gas forces (understood as function of time), met with in HCCI and PDD engines (at least those utilizing stoichiometric mixture, which is the most efficient thermodynamically, and also most efficient from the point of view of power/weight and power/volume parameters) are much higher than in conventional IC engines, and conventional mechanisms are unable to cope with such extreme loads. This is one of the reasons, for which the planned “HCCI engines” are to utilize the more efficient HCCI mode of operation only while producing power at a moderate rate (and working on loan mixtures), converting into ordinary Diesel mode of operation when the power demand rises (the other reason is that IC engine working on loan mixture produces less pollutant nitrogen oxides).

It is to be stressed that none of the non-conventional engine designs in United States Patent and Trademark Office (USPTO) and European Patent Office (EPO) patent data bases offers satisfactory mechanical structure of the ICE suitable for coping with extreme loads while assuring engine's compactness and good sealing. Moreover, none of the known positive-displacement internal combustion engines approaches highly desirable structural simplicity of gas turbines.

### SUMMARY OF THE INVENTION

Thus the principal objective of the present invention is to provide a high power density positive-displacement internal combustion engine of simple and extraordinarily robust structure, capable to withstand extremely high loads and thus to utilize highly efficient ultra-high pressure Diesel cycle or HCCI and PDD modes of operation without increasing specific loads of engine's elements beyond limits that are standard for ordinary piston engines and without decreasing mechanical efficiency of the engine.

Another objective of the invention is to provide a structure for a valve-less two stroke engine that guarantees good constraint for engine's piston and piston sealing elements.

Yet another objective of the invention is to provide a structure for the internal combustion engine with no hot load bearing sliding elements.

Another objective of the invention is to substantially increase thermal efficiency of engines by improving combustion and increasing such parameters as maximum combustion pressure without increasing specific loads of engine's parts.

Yet another objective of the invention is to provide a structure for positive displacement engines that offers substantial improvement of such important engine parameters as swept volume/total volume, power/total volume and power/weight ratio, without increasing specific loads and thus without sacrificing engine's strength and reliability.

Another objective of the invention is to provide a structure for the positive displacement engines that offer a large variety of engine's configurations (e.g. considerable variety of scavenging systems, ignition systems etc.) capable of being adjusted to various specific requirements.

Yet another objective of the invention is to provide rotary engines that have sealing almost as simple, tight and reliable as conventional ones and much simpler, tighter and much more reliable than conventional (Wankel) rotary engines.

It is clear that at the core of such an engine should be a mechanism, desirably the strongest and simplest mechanism in existence, that would provide the optimal method for converting gas pressure directly into rotary movement of a solid body.

In order to find such a mechanism some initial conditions should be imposed upon it. Thus gears (toothed wheels) or other mechanisms comprising elements meeting along a line, mechanisms complex from kinetic point of view (for example comprising elements executing complex motion) loaded with extreme gas forces and rendering the engine difficult to seal are unacceptable.

Thus the general idea behind the invention is to take a solid body, as regular as possible, cut out the combustion chamber, and cut the remaining portion of the body along some surfaces (preferably planes) into a minimum number of elements of a mechanism capable of converting gas pressure directly into driving torque (that is to say executing pure rotary movement, or at least “close” to it). This would provide the simplest, strongest, most robust and compact (no vacuum inside of the engine) structure of internal combustion engine, capable of bearing extreme mechanical loads produced by high-efficiency thermodynamic processes without increasing specific loads and friction losses, and substantially improving weight/power ratio at the same time, thus displaying substantial overall efficiency improvement over existing heat engines.

The construction of the strongest mechanisms in existence presented below provides strong indications that the proper form of the engine capable to satisfy all the above-formulated requirements is the oscillating or rotary/oscillating spherical engine.

Thus another, more specific objective of the present invention is to provide the proper form of the oscillating and rotary/oscillating spherical positive displacement engine without drawbacks (structural weakness, difficult sealing, compare U.S. Pat. Nos. 6,325,038, and 6,941,900, and Russian patent 2,227,211) of known spherical engines, having some specific qualities of gas turbines, namely high power density, structural simplicity combined with good driving torque smoothness, having scavenging system that makes the gas flow almost as smooth as (and similar to) that to be found in gas turbines and assuring engine's good balance thus enabling it to rotate at high speeds.

Spherical positive displacement machines (i.e. positive displacement machines with substantially spherical working chamber) are known from the prior art, however none of known designs provides a proper form of the machine, and the only mildly successful device of this type is a low-pressure pump (used to pump dense liquids, e.g. liquid soap). The reason is that the known designs (which usually adopt, at least partially, the general scheme of the universal joint) utilize elements of complicated and weak structure, which prevents the machines from exploring full potential (e.g. strength and compactness, ability to apply simple symmetric sealing) of mechanisms having a kind of spherical symmetry (see U.S. Pat. Nos. 6,325,038 and 6,941,900, and Russian patent 2,227,211; the design U.S. Pat. No. 6,325,038 is the best of its kind in the US and EPO patent data bases, however stops short of employing the optimal form of the spherical mechanism provided by the general principle of cutting a sphere along planes to obtain a mechanism presented in paragraph 3 above; it is to be stressed that an engine with the kinetics of the engine of the patent U.S. Pat. No. 6,325,038 is within the scope of the presented invention, and the machine provided by the method of paragraph 3 above is by far stronger and by far simpler structurally).

Thus the presented invention provides the proper form of the spherical engine, and explores to the full extent the potential of the spatial mechanism presented in a paragraph below i.e. its unique strength and compactness, possibility to apply simple completely symmetrical sealing, and variety of allowable kinetics. It is to be stressed that there is a considerable variety of spherical engines within my engine system, e.g. oscillating and rotary ones with a variety of scavenging systems, all based on the same mechanism.

### BRIEF DESCRIPTION OF THE DRAWINGS

FIGS. 1-5 illustrate the construction of my mechanisms described in the next paragraph.

FIGS. 6-14 depict one preferred embodiment of the invention. This is a spherical HCCI engine producing 2 power impulses per shaft revolution.

More specifically, FIGS. 6, 7 are two general views of the engine,

FIGS. 8, 9 are two expanded views;

FIG. 10 is a cut-away view of the engine in the assembled configuration;

FIGS. 11 and 12 provide details of engine's main and intermediate rotors;

FIG. 13, respectively 14, is a longitudinal and transverse cross-sections.

FIGS. 15-22 and 23-29 depict another preferred embodiment of the invention. This is a spherical rotary Diesel cycle engine.

FIGS. 15, 16 are two general views of the engine.

FIGS. 17, 18 are two expanded views of the engine.

FIGS. 19,20 are two cut-away views of the engine in the assembled configuration.

FIG. 21, respectively 22, is two views of the intermediate rotor, respectively the main rotor of the engine.

FIGS. 23-29 depict another variant of the engine (with differently shaped moving parts).

FIGS. 23 and 24 are two expanded views of another variant of the engine.

FIG. 25 shows three moving parts of another variant of the engine.

FIGS. 26 and 27 are two cut-away views of another variant of the engine.

FIG. 28 (respectively 29) is a view of the main (respectively intermediate) rotor.

FIGS. 30-38 illustrate yet another preferred embodiment of the invention (another rotary spherical engine).

FIG. 30 is a general view of the engine.

FIG. 31 and 32 are two expanded views of the engine.

FIG. 33 is a cut-away view of the engine.

FIG. 34 is a transverse cross section of the engine exhibiting its combustion chambers.

FIGS. 35, 36 are two views of the auxiliary rotor.

FIGS. 37, 38 are two views of the intermediate rotor.

FIGS. 39-45 depict the oscillating spherical engine according to the invention.

FIGS. 39 and 40 are two general views of the engine.

FIGS. 41, 42 are two cut-away views of the oscillating spherical engine.

FIGS. 43, 44 are two expanded views of the engine.

FIG. 45 is a longitudinal section of the engine.

### DETAILED DESCRIPTION OF THE PREFERRED EMBODIMENTS

### 0. Main Geometric Construction

Now I present a short description of my method for achieving the strongest mechanism in existence capable of being applied in positive displacement engines. In fact the construction of these mechanisms lies at the very heart of the present invention.

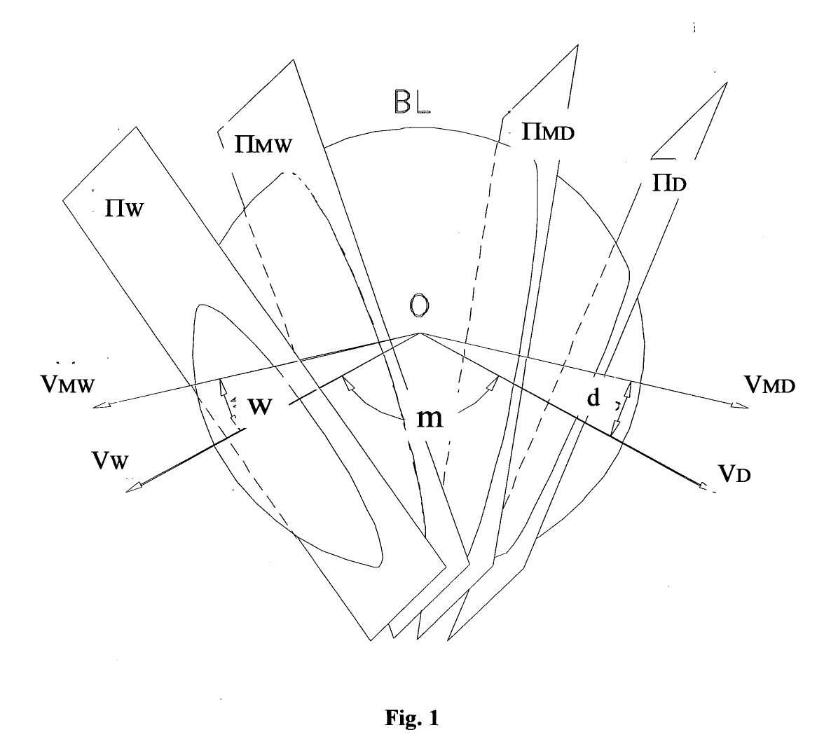

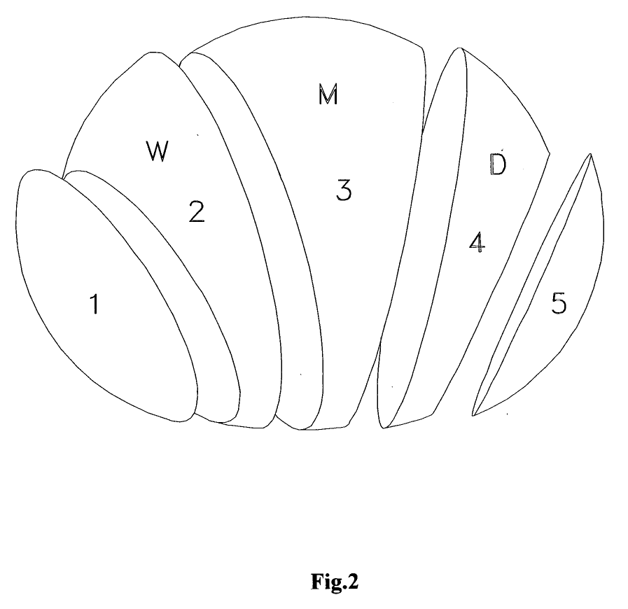

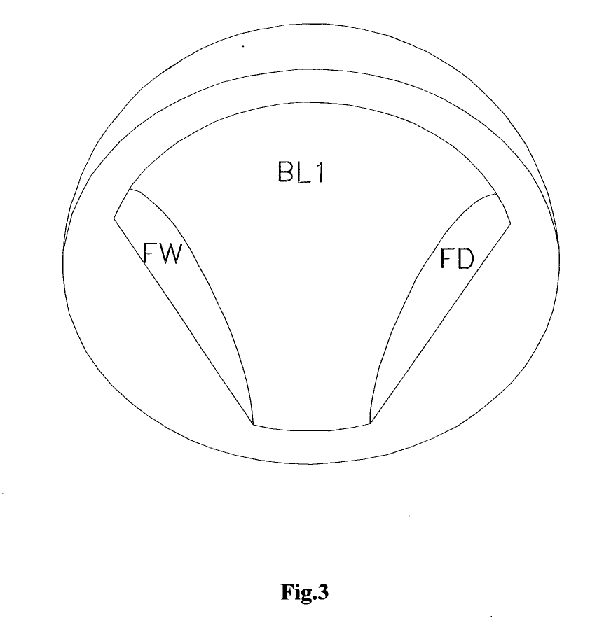

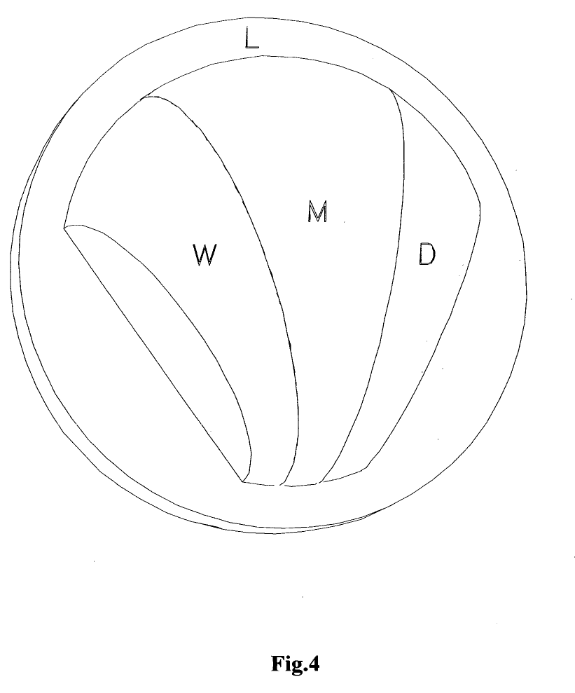

The construction will be carried out in several simple steps (see FIGS. 1-7).
A. In the Euclidean 3-dimensional space choose a ball BL of radius R and center O and four vectors ν_{w}, ν_{d}, ν_{mw} and ν_{md} of length R and based at the point O (FIG. 1). Any two of these vectors should not be parallel.
B. Fix planes π(w), π(d), π(mw) and π(md) perpendicular to the vectors ν_{w}, ν_{d}, ν_{mw} and ν_{md} respectively so as each of these planes non-trivially intersects the ball BL (FIG. 1).
C. Cut the ball BL along the planes π(w),π(d),π(mw) and π(mw) into five components, say 1,2,3,4,5 (FIG. 2). Reject two extreme components 1 and 5 and save three central elements 2,3,4. These elements are segments of the ball BL bounded respectively by pairs of the planes: (π(w),π(mw)), (π(mw),π(md)) and (π(d),π(md)), and are denoted by W, M, and D respectively (FIG. 2). W, M, and D are the “moving” links of the desired mechanism.
D. Take another element L with (substantially) spherical bore chamber BL1 of radius R and two flat surfaces FW and FD perpendicular to the vectors ν_{w}, ν_{d} respectively; the distance from the center of the chamber BL1 to the flat surface FW (resp. FD) equals the distance from the center of the ball BL to the plane π(w) (resp. π(d)) (FIG. 3). The element L will be called the body of the mechanism.
E. Insert the elements W, M, and D in the bore chamber BL1 of the element L as shown in FIG. 4 (clearly this can be done in only one way).

The resulting device is the desired (spatial) mechanism. It has five kinetic couples, namely (L,W), (W,M), (M,D), (D,L) and (ML). The couples (L,W), (W,M), (M,D), (D,L) are higher rotational kinetic couples, while the couple (M,L) is a lower ball joint-like kinetic couple.

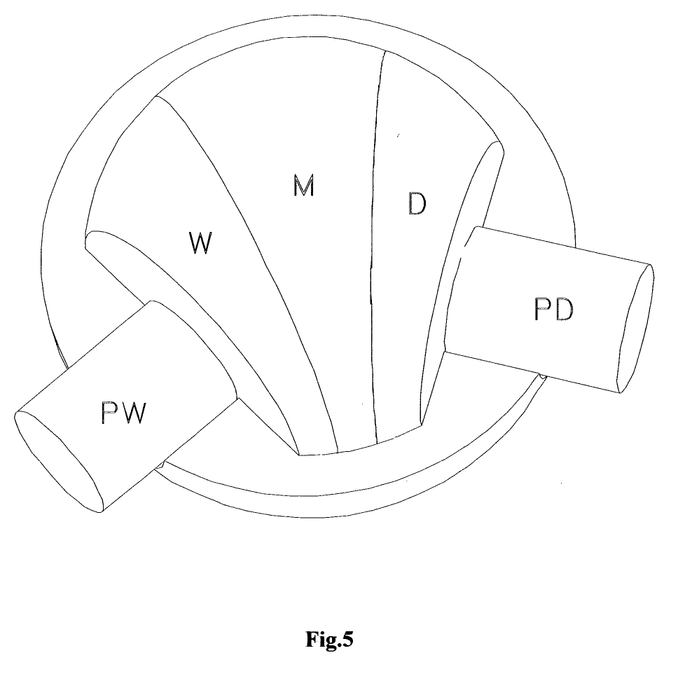

In order to enable receiving mechanical energy produced inside the mechanism body, we have to make “moving” elements of the mechanism accessible from the exterior of the body L. This is achieved by equipping said body L with one or two circular bore chambers that accommodate a pin attached to the element W or D or both (FIG. 5).

For the purpose of the present patent specification and the patent claims I assume the following Definition:

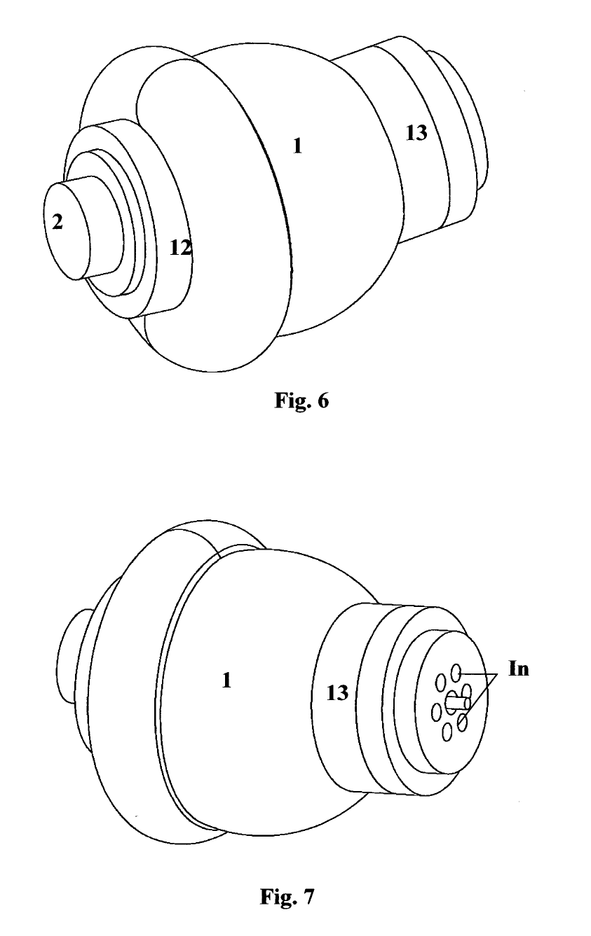

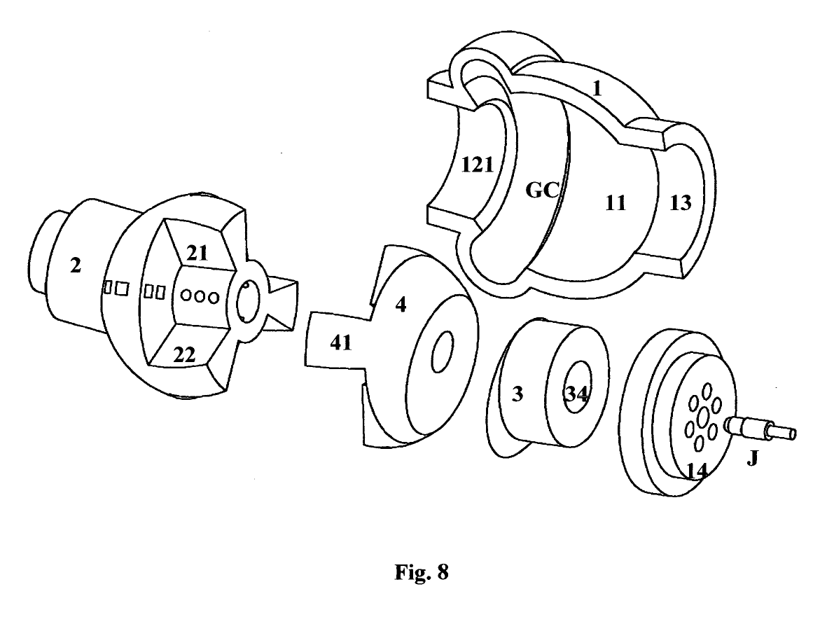

DEFINITION. By a spatial eccentric is understood a segment of a ball bounded by two planes, wherein on of said planes is inclined relative the other plane at a non-zero angle.
REMARK 1. In general this procedure provides spatial mechanisms the “moving” elements of which assume the general form of spatial eccentric (see the Definition above), but in a limiting case it can give flat mechanisms, and in this case all the parts of the mechanism are obtained by cutting a cylinder rather than a ball into 4 pieces, each of them bearing circular symmetry. From the mathematical point of view, the flat mechanism alluded to above is a limiting case of the spatial mechanism obtained by placing the point O at infinity and letting the radius R tend to infinity. In this way we get a mechanism composed of three ordinary flat eccentrics W, M, D placed in the body L, which is composed of four higher (rotational) couples (L,W), (W,M), (M,D), (D,L). In this case the vectors ν_{w}, ν_{d}, ν_{mw} and ν_{md} (directional vectors of the axes of rotation of the kinetic couples) are all mutually parallel (FIGS. 6 and 7). The present invention utilizes only spatial mechanisms.
REMARK 2. It is clear from this description and accompanying figures that this is the strongest mechanism in existence (which is not merely a kinetic pair such as the ball joint) as its 3 moving parts occupy the whole internal space of its body and all its components assume general form of the ball or segments of a ball. Therefore the mechanism is particularly well suited for heavy-duty applications, including high power density, extreme loads, detonation and HCCI engines. Another unusual feature of the presented 4-link spatial mechanism is that its four elements form five kinetic pairs, namely (L,W), (W,M), (M,D), (D,L) and (N,L). The presence of an extra kinetic pair (M,L) (which is a lower ball joint-like kinetic couple) contributes significantly to the mechanism strength and further decreases specific loads.
REMARK 3. It is clear that kinetics of the spatial mechanism is determined exclusively by the relative position of the vectors ν_{w}, ν_{d}, ν_{mw} and ν_{md} or, equivalently, by the angles between these vectors (this will be discussed below).

Similarly, kinetics of the “flat” mechanism is determined by the distances between the axes of rotation of the mechanism elements.

In order to determine kinetics of the spatial mechanism we join the end points of the vectors ν_{w}, ν_{d}, ν_{mw} and ν_{md} by geodesic arcs placed in the sphere BL to obtain the ordinary spherical geodesic tetragon (FIG. 1). This proves that from the kinetic point of view our mechanism is the ordinary spherical four-bar linkage.

Similarly, from the kinetic point of view, the “flat” mechanism is the usual flat four-bar linkage. This can be seen by suitably joining by straight segments the intersection points of the rotation axes of the elements W, M and D determined by the vectors ν_{w}, ν_{d}, ν_{mw} and ν_{md} with a plane perpendicular to these vectors.

Thus any kinetic pair of the presented mechanism is the rotary or spherical one, and the mechanism is capable of producing rotary movement of one of its elements from oscillating movement of another element and rotary movement of one of its elements from rotary-oscillating movement of some other elements. This feature is utilized in my engines presented in the next section.
REMARK 4. Specific loads within the mechanism (given external loads applied to the mechanism) depend on the relative position of the vectors ν_{w}, ν_{d}, ν_{mw} and ν_{md}, as well as on the radius R and distances from the center O to the planes π(w),π(d),π(mw) and π(md). This problem will be briefly discussed in forthcoming paragraphs.
REMARK 5. It is worth noticing that the presented mechanism is not only simple structurally, but also easy to manufacture. All its moving elements have the same very simple structure thus can be manufactured using the same general-purpose machines like forging machine, lathe and milling machine, quite unlike the mechanism of the ordinary piston engine comprising technologically different and complicated elements (crankshaft) and requiring highly specialized equipment to manufacture.

Throughout the patent specification I will use the following nomenclature: The three moving elements (segments of the ball) of the mechanism obtained by the procedure described above I will call “spatial eccentrics” or simply eccentrics. When applied to spherical engine I will call these elements as follows: W=2—main rotor, M=4—intermediate rotor, D=3—secondary rotor; the name “main rotor” is reserved for the element used to receive driving torque, and this element (spatial eccentric) is usually equipped with a pin or a shaft to receive useful power.

Below I present a variety of rotary/oscillating and oscillating spherical engines utilizing various variants of the spatial mechanism constructed above. All the designs are based on the following three principles:
PRINCIPLE 1. Cut out the combustion chambers (or “pistons”) in some elements of the mechanism presented above.
PRINCIPLE 2. Make the engine producing as many power strokes per revolution as possible. Make phasing of power strokes optimum.
PRINCIPLE 3. Make the engine as well balanced as possible.

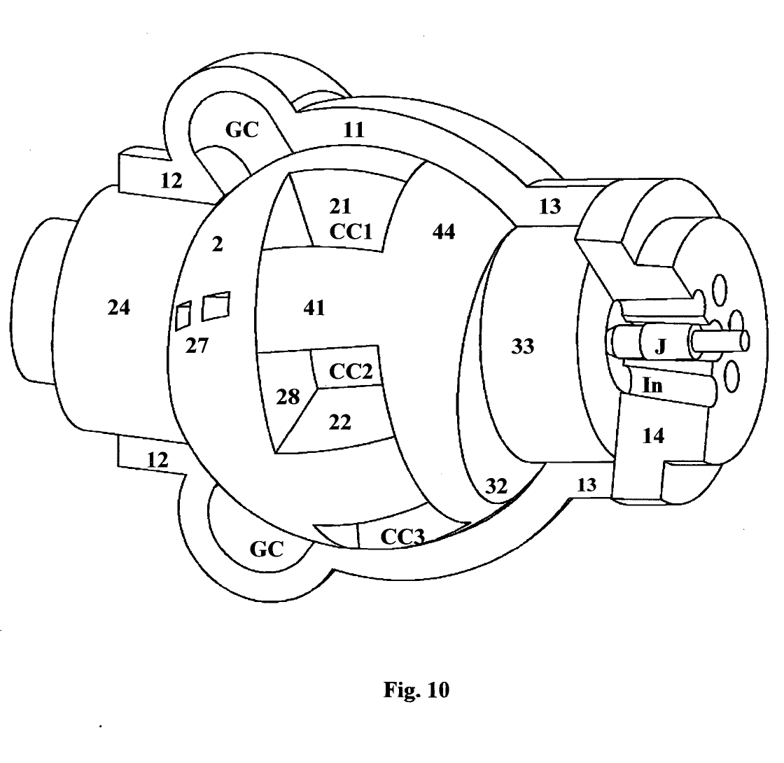

### 1. Rotary/Oscillating Spherical Engine I (FIGS. 6-14)

The engine is a HCCI rotary one having 3 moving parts and producing two power strokes per shaft revolution (let us note that rotary “spatial” engines with only 3 moving parts and producing 4 and even 6 power strokes per shaft revolution are also within the scope of the presented invention). It utilizes the mechanism shown in FIG. S with geometric parameters described below.

The engine has 3 moving parts: main rotor 2=W, intermediate rotor 4=M, and secondary rotor 3=D equipped with suitable spherical and flat surfaces used to determine engine's kinetics. The geometric parameters of the mechanism are as follows: the angle between the axis of rotation of the main rotor 2 relative the body 1 and the axis of rotation of the intermediate rotor 4 relative the main rotor 2 and the angle between the axis of rotation of the secondary rotor 3 relative the body 1 and the angle of rotation of the intermediate rotor 4 relative the secondary rotor 3, are both greater than the angle between the axes of rotation of the intermediate rotor 4 relative the main 2 and secondary 3 rotors (and preferably the angle between the axis of rotation of the main rotor 2 relative the body 1 and the axis of rotation of the intermediate rotor 4 relative the main rotor 2 equals the angle between the axis of rotation of the secondary rotor 3 relative the body 1 and the angle of rotation of the intermediate rotor 4 relative the secondary rotor 3); moreover the angle between the axes of rotation of the intermediate rotor 4 relative the main 2 and secondary 3 rotors is greater than the angle between the axes of rotation of the main 2 and secondary 3 rotors relative the body 1. Thanks to this specific geometry the mechanism produces rotary movement with non-constant rotational speed of the secondary rotor from the rotary movement with constant rotational speed of the main rotor, and both the kinetic couples (2,4) and (3,4) are oscillating ones.

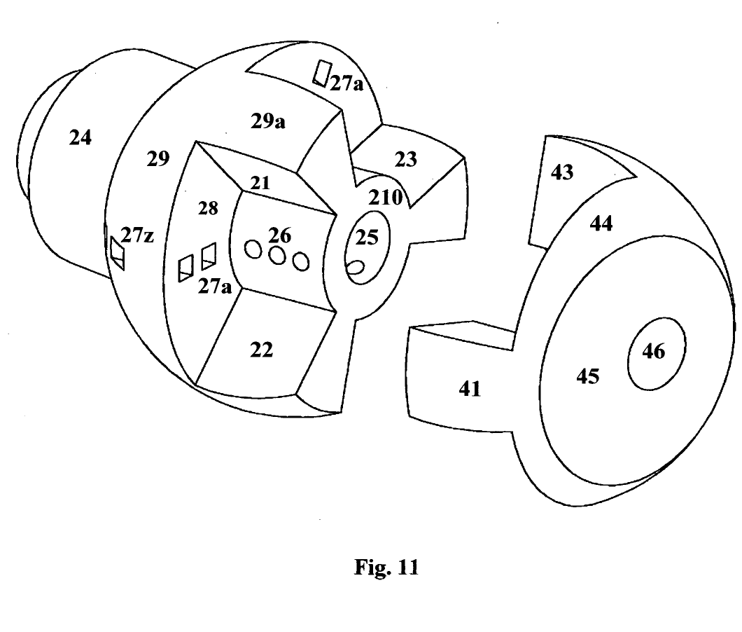

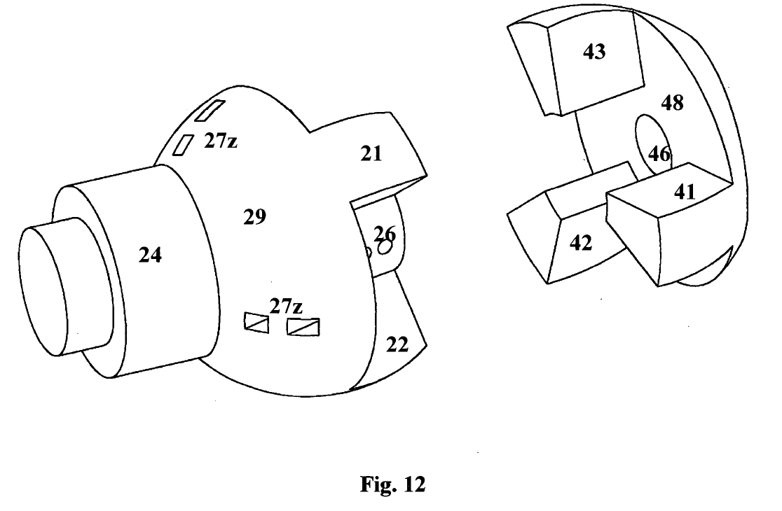

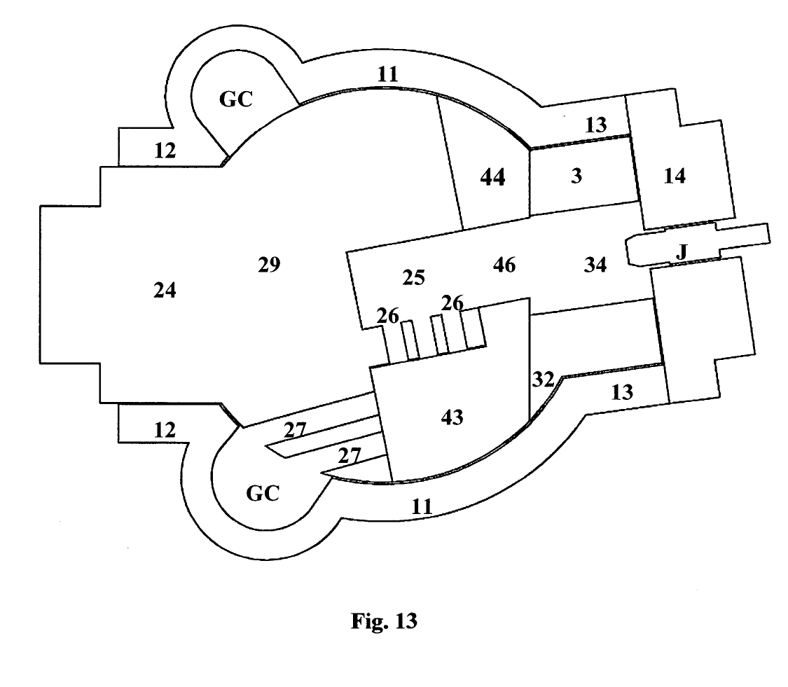

Massive main rotor 2 (FIGS. 11, 12) has its “cold section” and “hot section”. The “cold section” has a spherical portion 29 and a shaft (or pin) 24 projecting from the spherical portion. The “hot section” of main rotor 2 has a “hot” flat surface 28 (used to define engine mechanism's kinetics), which carry 3 massive fins (or pistons) 21, 22, 23; the outer surface 29a of the pistons (which matches the inner surface of the engine main spherical chamber) is spherical. The main rotor 2 has also a central tubular portion 210 supporting the pistons at their inner side. There is a centrally placed circular air passage 25 in said tubular section 210 of the “hot section” of the main rotor 2 and 3 assemblies of radially disposed air passages 26 placed between pistons 21, 22, 23 in constant communication with said central air passage 25. There are also three assemblies of hot gas outlet passages 27 placed in the massive spherical section 29 of the main rotor 2; the hot gas passages at their one end have inlet ports 27a placed between the pistons 21, 22, 23, and at their other end have outlet ports 27z placed on the spherical surface of the spherical section 29 of the main rotor 2.

Intermediate rotor 4 (FIGS. 11, 12) has its spherical section 44 confined by a “hot” circular flat surface 48 matching the “hot” flat surface 28 of the main rotor 2 and “cold” circular flat surface 45 inclined one relative the other at an angle dictated by the mechanism kinetics. The “hot” flat surface 48 carries three massive fins (or pistons) 41, 42, 43 cooperating with the pistons 21, 22, 23 placed on the main rotor 2. There is also a central circular air passage 46 placed in the intermediate rotor 4.

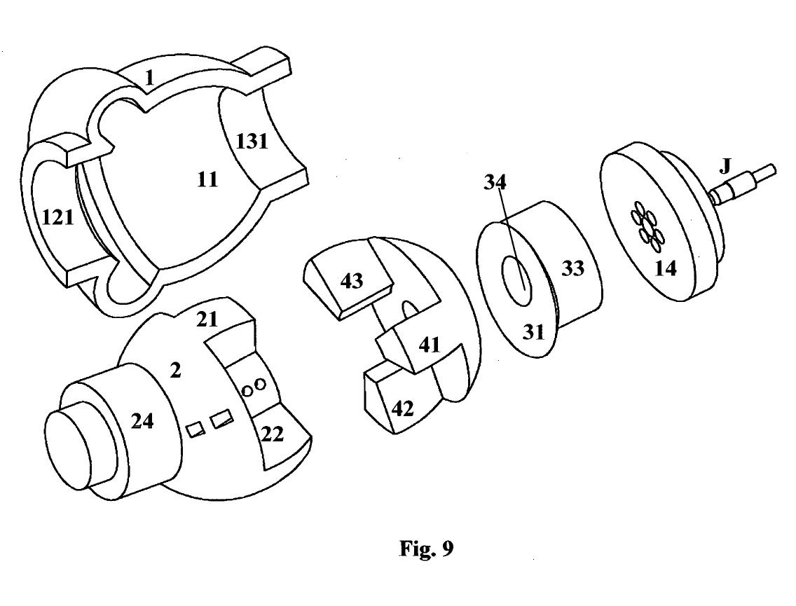

Secondary rotor 3 (FIGS. 8, 9, 10, 13) has its spherical section 32, which at one side has flat circular surface 31 cooperating with the “cold” flat surface 45 of the intermediate rotor 4; at the other side of said spherical portion 32 of the secondary rotor 3 there is a massive pin 33 inclined at a suitable angle relative the flat surface 31 dictated by engine mechanism's kinetics. Cutting through the secondary rotor 3 there is a circular air passage 34 with an air inlet 341 placed at the pin 33. The pin 33 of secondary rotor 3 drives the fuel injector, thus there are suitable cams placed on it (not shown).

Engine's moving elements are constructed so as to minimize moment of inertia of the intermediate 4 and secondary 3 rotors in comparison with the moment of inertia of the main rotor 2, which is used to receive driving torque.

Engine's body 1=L has spherical central section 11 with a spherical working chamber SC housing spherical sections of all three moving elements of the engine, and is composed of two parts. One of the parts 12 has a circular aperture 121 housing a bearing supporting the pin 22 of the main rotor 2, and a spiral gas collector GC in communication with hot gas outlet ports 27z placed on the spherical section of the main rotor 2; there is a gas outlet at one end of the spiral gas collector. The other part of engine's body 13 has a circular aperture 131 housing a bearing supporting the pin 33 of the secondary rotor 3, a collection of circular air inlets In in communication with the air passage 34 in auxiliary rotor 3, and a fuel injector J placed in proximity to said air inlets In.

Thus the engine has six combustion chambers CC1-CC6 confined by the (double-acting) pistons 21, 22, 23 and 41, 42, 43, “hot” flat surfaces 28 and 48 of the main 2 and intermediate 4 rotors, and the spherical wall of engine's working chamber SC.

Opening and closing of the air inlet passages 26 and hot gases outlet passages 27a are governed by the pistons 41, 42, 43 of the intermediate rotor 4.

Sealing rings (with spherical outer surface) and sealing bars provide sealing of the engine (not shown). Thus the sealing is completely symmetric and as simple, tight and reliable as that of ordinary piston engines.

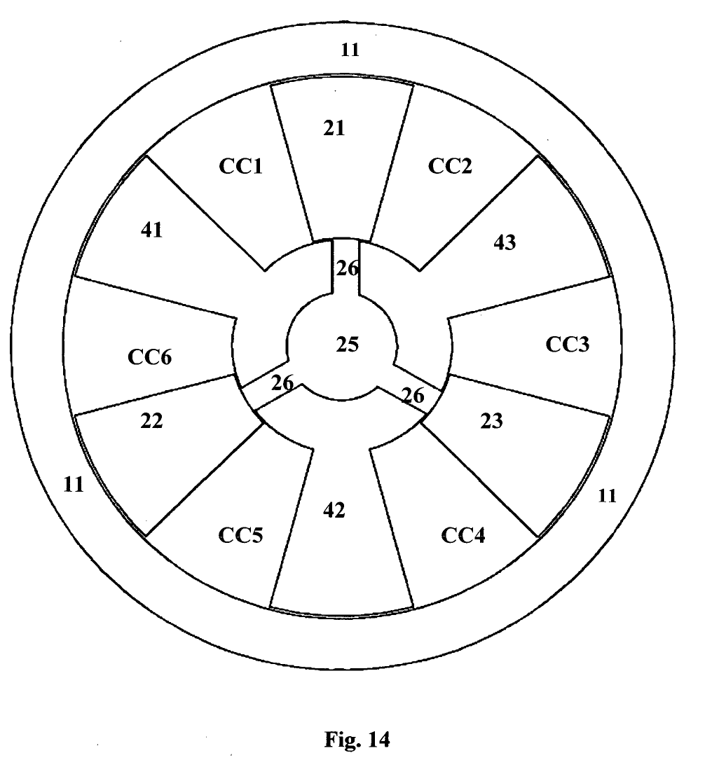

Here is a brief discussion of the engine work. The assembly of six combustion chambers CC1-CC6 is naturally divided into two sub-assemblies of three chambers each: CC1, CC3, CC5 and CC2, CC4, CC6. As the moving engine's parts rotate (to be more precise, as the main rotor 2 rotates with a constant rotational speed, the secondary rotor 3 rotates with changing rotational speed and the intermediate rotor 4 executes a compound rotational/wobbling motion relative engine's body 1), volume of any combustion chamber of one sub-assembly increases and volume of any combustion chamber of the other sub-assembly decreases. As volume of one group of the combustion chambers approaches its maximum, the pistons 41, 42, 43 of the intermediate rotor 4 open the inlet ports 27a placed between the pistons 21, 22, 23 on the “hot” flat surface 28 of the main rotor 2 and hot low-pressure gases driven by centrifugal forces exit said combustion chambers through said ports, flow through the hot gas passages 27 placed in the spherical section of the main rotor, enter the spiral gas collector GC in engine's body, and are finally exhausted. Next, as volume of the combustion chambers still rises, the pistons open air inlet ports 26 placed on the “hot” tubular portion 210 of main rotor 2. Fresh air, driven by centrifugal forces, enter the inlet port In placed at the part 14 of the engine body 1, fuel is injected by the injector J, and homogeneous charge is prepared in the air passages 34, 46 and 25 placed in the secondary 3, intermediate 4 and main 2 rotors respectively (FIG. 13). Then the air/fuel mixture passes through the central air passages in engine's rotors, and enters the three combustion chambers through the air passages 26 displacing remaining hot low-pressure gases; this is the scavenging. Next, as the rotors further rotate, volume of the combustion chambers decreases, the pistons close the inlet and outlet ports, and the homogeneous charge contained in said combustion chambers is compressed. As volume of the combustion chambers approaches their minimum, the homogeneous charge is ignited and hot high-pressure gases produced. Next the gases expand producing useful power (received from the main rotor 2). Next the whole process repeats with the two sub-assemblies of the combustion chambers subsequently interchanging their roles.

In this brief discussion I completely ignore the subtle problem of controlling this HCCI engine, as this is beyond the scope of the present patent application, the focus of which is on the mechanical aspects of the engine. Let us note that there is also a mechanically similar engine working on traditional Diesel cycle, the general layout of which (including the effective centrifugal forces-enhanced uniflow scavenging system) is completely analogous, with the only essential difference being a plurality of injectors adjacent to the combustion chambers (some minor structural changes are also required).

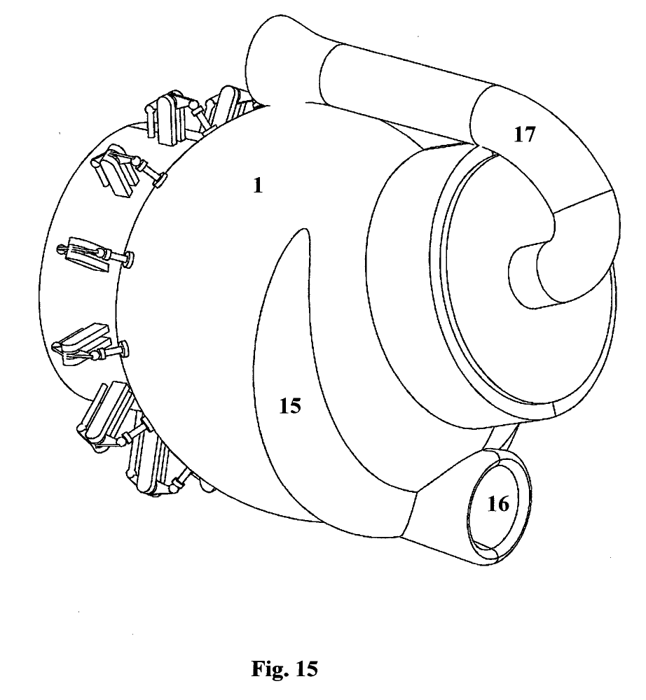

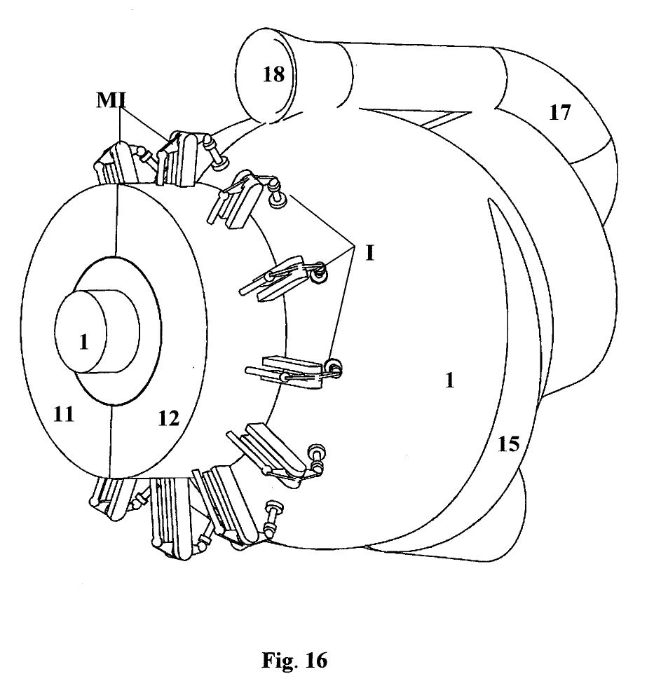

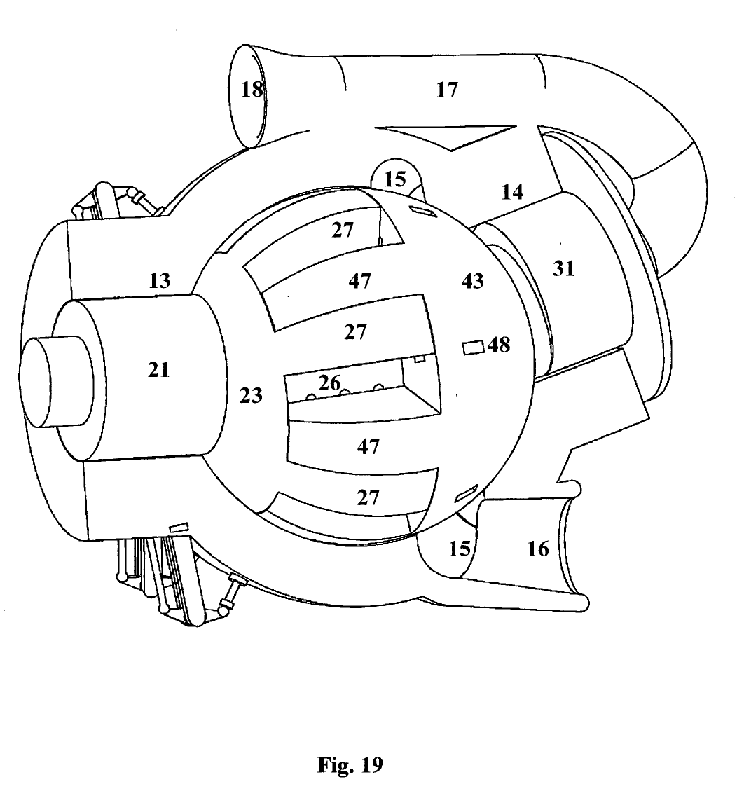

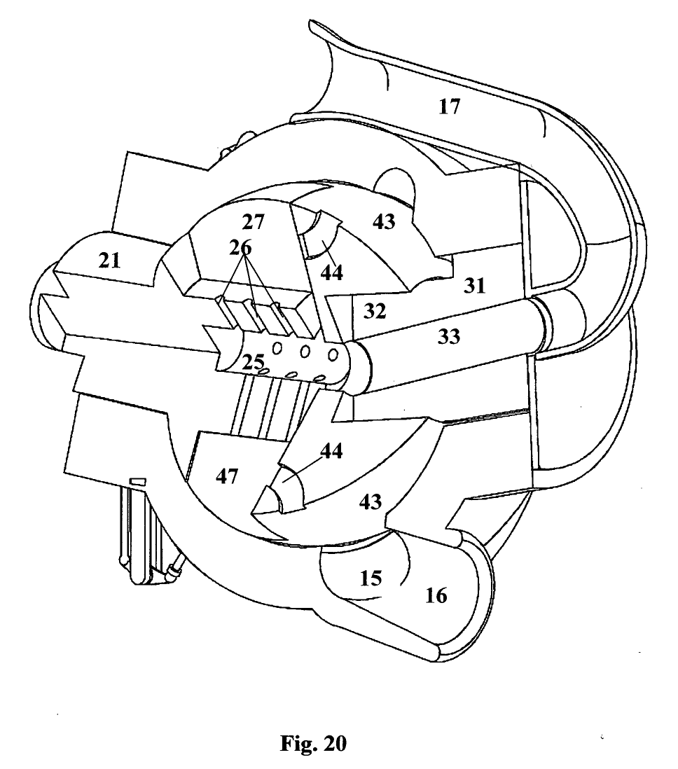

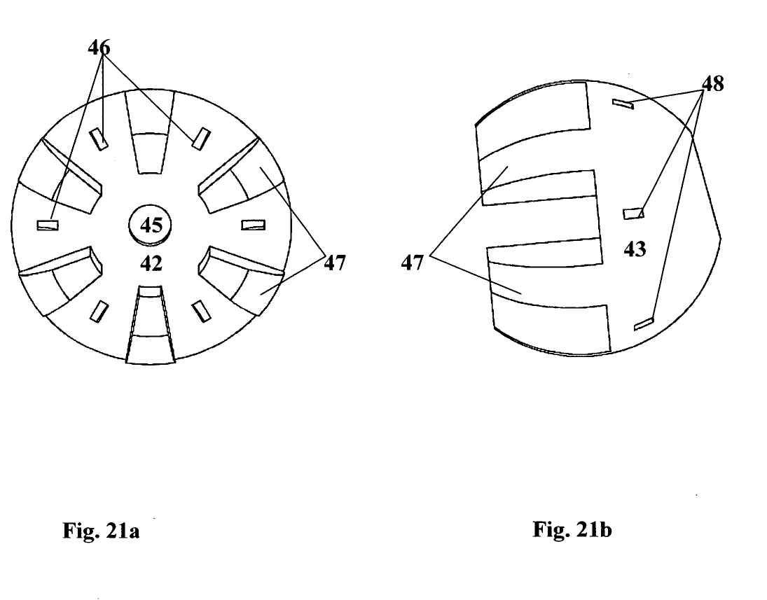

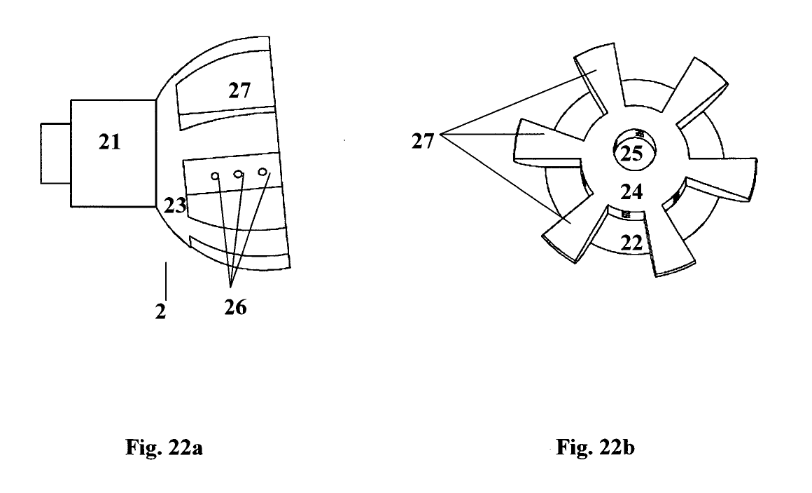

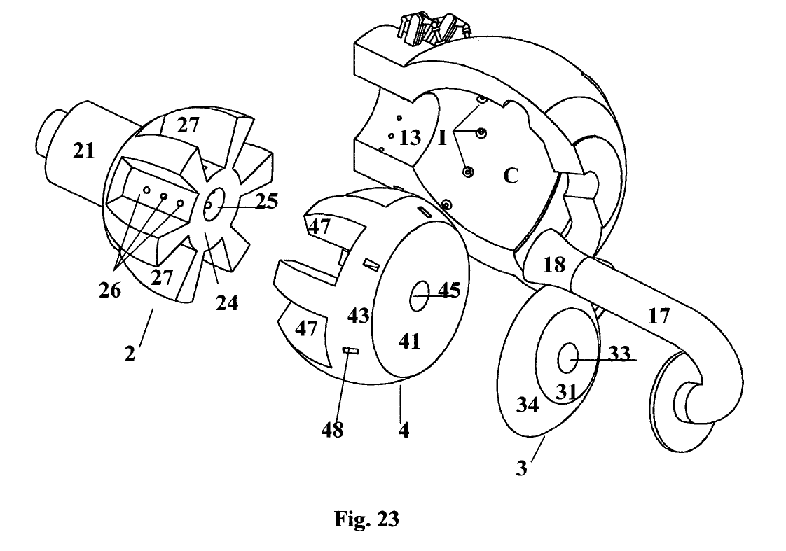

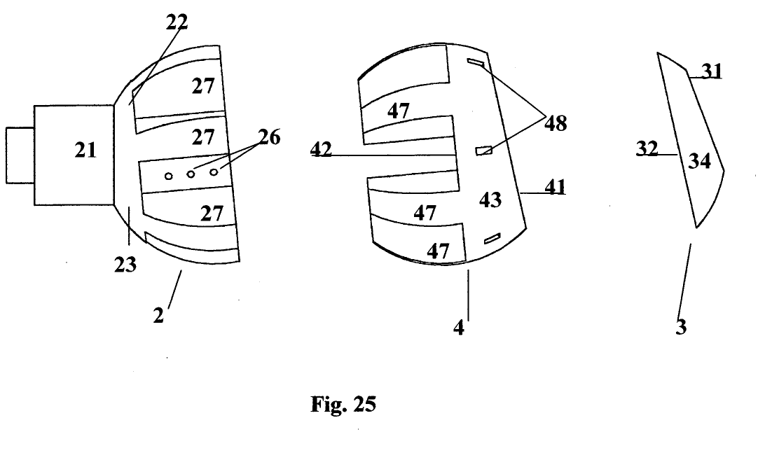

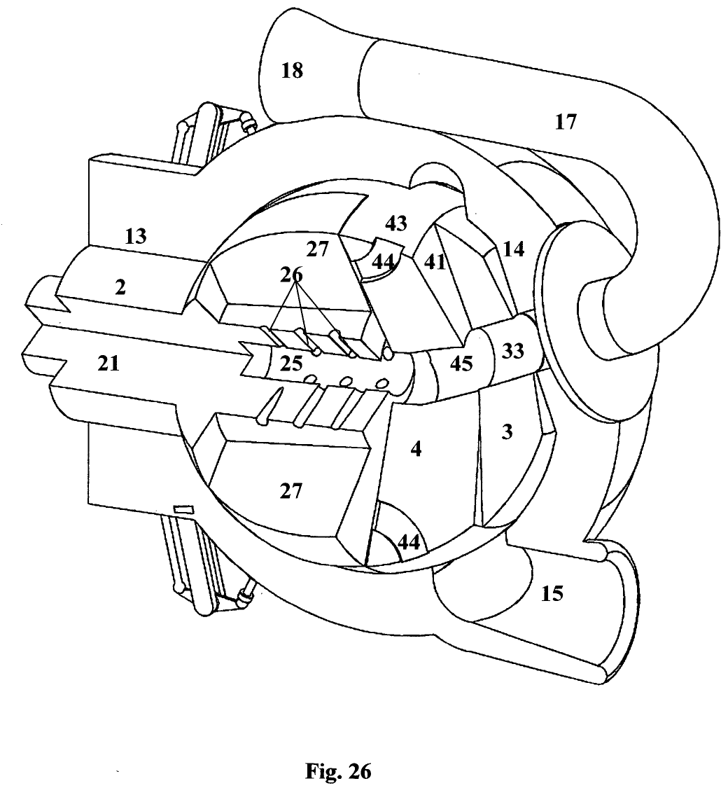

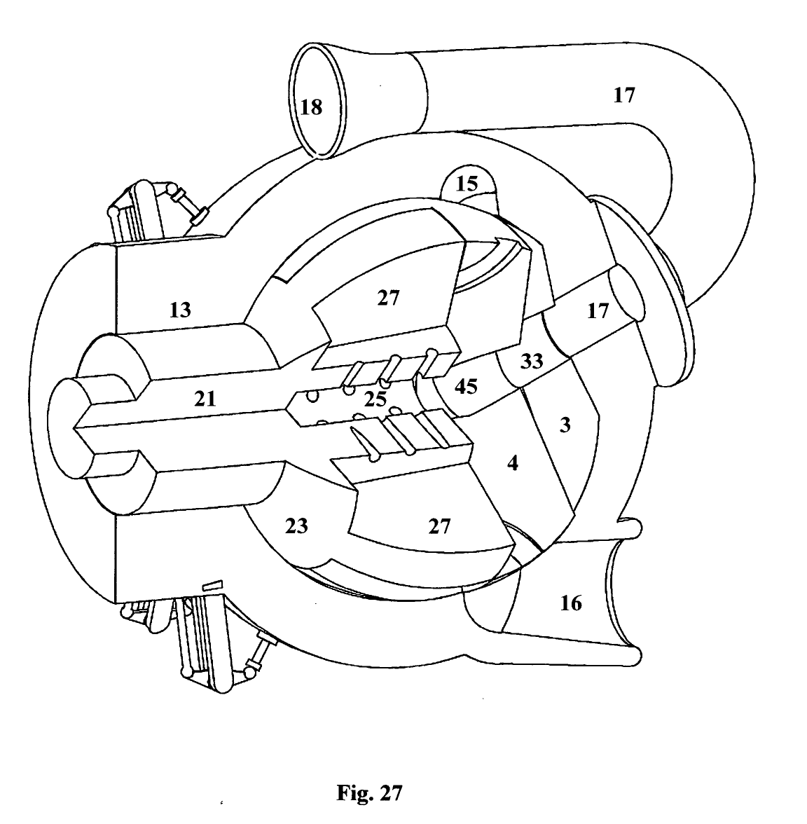

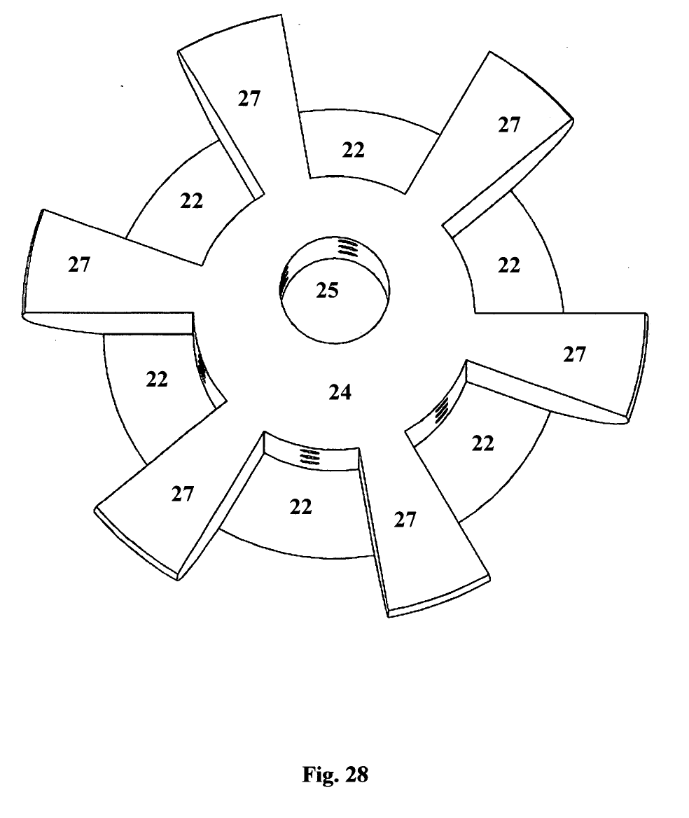

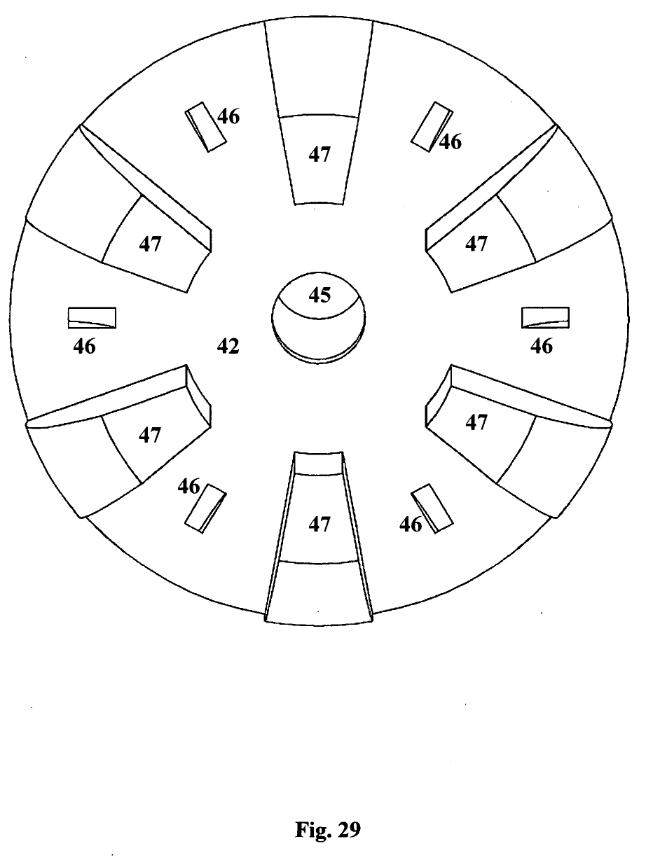

### 2. Rotary/Oscillating Spherical Engine II (FIGS. 15-22 and 23-29)

This is a two-stroke Diesel cycle rotary/oscillating spherical engine utilizing a spatial mechanism as described above. The design incorporates a self-sufficient (no separate scavenging pump) scavenging system featuring self-supercharging capabilities, similar to that of the engine 1; the engine produces two power impulses per each revolution of its shaft and is intended to be a simple, inexpensive, exceptionally reliable and durable, very high power/weight ratio source of power, particularly for light aircraft (including light helicopters), unmanned aerial vehicles (UAV), target drones, motor boats, small hovercrafts and sport motorcycles. The engine is constructed so as to maximize swept volume/overall volume ratio and minimize specific loads and mass forces, and to make the engine parts as simple and robust as possible. Since my spherical mechanisms of this type are the most robust and compact mechanisms (not reducing to kinetic couples) in existence, the engine is expected to display exceptional power/weight and power/overall volume ratios, and since its sealing is, unlike in Wankel-type engines, perfectly symmetric and similar to that of conventional piston engines, I expect this spherical engine would also display exceptional durability and reliability, provided its sealing system is made of good materials.

The engine consists of body 1, main shaft/rotor 2, secondary rotor/oscillator 3, and intermediate rotor/eccentric 4. The rotors 2, 3 both pivot directly in the body 1. Intermediate rotor/eccentric 4 oscillates by certain angle <2π relative each of the rotors 2 and 3, and executes complex rotary-nutating movement relative the body 1. All the axes of rotation of all the kinetic couples intersect at a precisely one point P, namely the center of engine's spherical chamber (“cylinder”) (this is the necessary and sufficient condition for the mechanism to move in the required manner). There are three different modes of kinetics of the mechanism (depending on its geometry) applicable in engines of this type. Namely the engine mechanism may produce rotary motion of the secondary rotor (or oscillator) 3 of non-constant rotational speed out of rotary motion of the main rotor 2 of constant rotary speed, and average rotational speed of both the rotors is the same (we average over the period of rotation of any of the shafts)—then the intermediate rotor oscillates relative both the main and secondary rotors, and the mechanism has two oscillating kinetic couples; this mechanism is utilized in a spherical engine producing 4 power strokes per revolution. The mechanism may also produce rotary motion of the secondary rotor 3 of non-constant rotational speed out of rotary motion of the main rotor 2 of constant rotary speed, and average rotational speed of one of the rotors is double the average rotational speed of the other—in this case the mechanism has only one oscillating kinetic couple and can be used in a spherical rotary engine producing 2 power strokes per revolution of its main shaft; or the mechanism may produce oscillating motion (relative the engine body) of the secondary rotor/oscillator 3 out of rotary motion of the main rotor 2. This last mode of movement of the mechanism will be used in spherical oscillating engine. The engine of the present design utilizes a mechanism of the first or second type described above.

The engine is shown in accompanying FIGS. 15-22 and 23-29 (another variant with differently shaped moving parts and the same kinetics).

The engine comprises four major parts: body 1, main rotor/oscillator 2, secondary rotor 3 and intermediate rotor 4. The body 1 (see FIGS. 15-20) is substantially spherical of shape. It is composed of two parts (hemispheres) 1 1, 12. Placed in body 1 there is a spherical chamber C, twelve injectors I corresponding to their respective engine's working chambers, suitable mechanisms MI (composed of rocking levers and pushing rods) driving said injectors, and bearings 13, 14 supporting the main 2 and secondary 3 rotors of the engine. There is also a circular hot gas passage 15 placed in the engine body 1, said gas passage being equipped with exhaust port 16, and long air passage 17 with its air intake manifold 18 attached to the engine body 1.

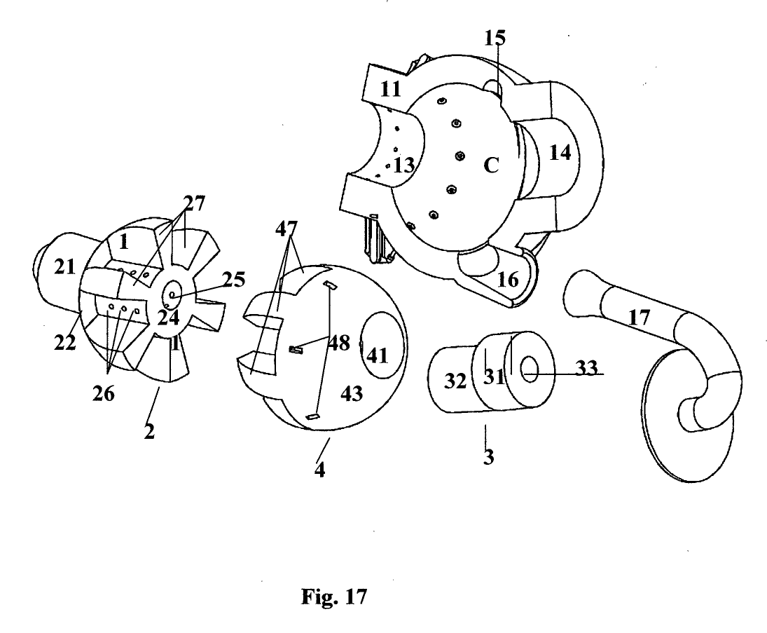

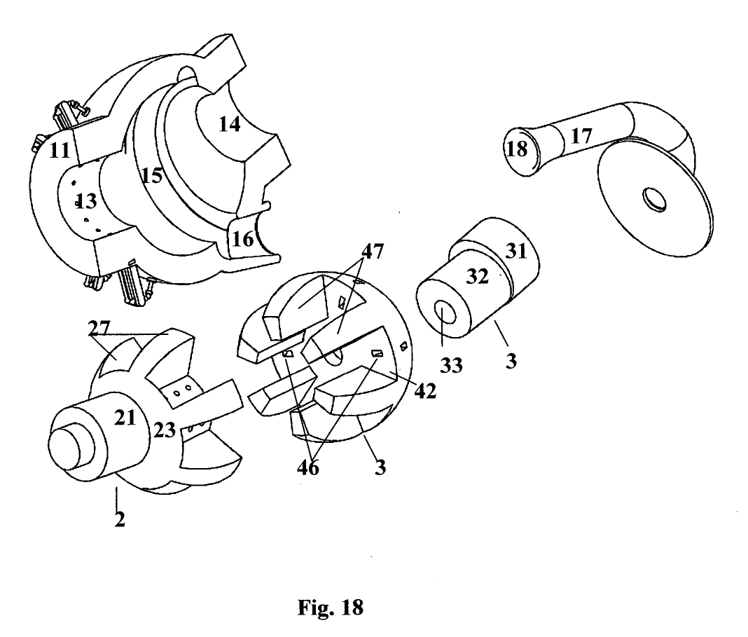

The main rotor 2 (see FIGS. 17-20, and particularly 22) has main pin 21, spherical surface 23, flat surface 22, and central ring-shaped member 24. Main pin 21 pivots in the bearing 13 in the body 1, while the spherical surface 23 slides over the inner spherical surface of the cylinder C. The flat surface 22 of the shaft 2 support the intermediate rotor 4. There are six double-acting pistons 27 fastened to (or manufactured as a unique whole with) the main rotor's 2 flat surface 22 and central ring 24. There are also suitably phased cams (not shown) placed on the main pin 21. A main fresh air passage 25 cuts through the central ring 24; there are also disposed radially fresh air passages 26 in said central ring 24 placed between the pistons 27. The cams drive injectors I, thus separate camshaft is not needed. This relatively large number of pistons enables of decreasing piston's stroke without decreasing overall swept volume, thus minimizing the engine parts accelerations and mass forces, and improving engine's balance.

Intermediate rotor 4 (17-20, and particularly 21), has bearing 41 supporting auxiliary shaft 3, spherical surface 43, and flat surface 42. There are also six double-acting pistons 47 fastened to the flat surface 42. There are also hot gas passages 44 placed in the body of the intermediate rotor 4 with their inlet openings 46 placed on the flat surface 42 and outlet openings 48 placed on the spherical surface 43. Fresh air passage 45 is formed in the central part of the body of intermediate rotor 4.

Secondary rotor 3 has a main pin 31 pivoting in bearing 14 in the engine body, an auxiliary pin 32 inclined relative the main pin 31 at an angle dictated by the engine kinetics and pivoting in bearing 41 placed in intermediate eccentric 4, and a centrally placed air passage 33.

Lubricating oil cools the pistons, and relevant cooling system (not shown) consists of oil conveyances placed in the engine body 1, and the engine moving parts 2,3 and 4 (in particular they pass through all engine's pistons). The oil flows through circular oil passage placed in the engine body, and driven by centrifugal forces generated by engine's rotating parts enters successively oil conveyances placed in secondary rotor 3, intermediate rotor 4 and main rotor 2 thus cooling engine's pistons, and finally exit the engine through another circular oil passage placed in the engine's body. Oil is being cooled in a suitable cooler (not shown).

Now a brief description of the engine (in this instance a Diesel-cycle two stroke engine) work follows. The engine has twelve varying-volume working chambers C1-C12 of precisely the same construction, bounded by engine's pistons 27 and 47 and inner wall of the spherical chamber C. Fresh air enters the engine through the air intake manifold 18, and successively flows through air passages 17, 33, 45 and 25. As volume of a working chamber, say C1, approaches its maximum, shaft piston 27 opens hot gas passage 44, and hot low-pressure gases contained in said working chamber C1, driven by centrifugal forces, exit it through said gas passage 44, and next flow through circular gas passage 15 and exit the engine through exhaust manifold 16. A moment later intermediate eccentric piston 47 opens air passage 26, and fresh air, driven by centrifugal forces, enters working chamber C1. As engine's shaft 2 further rotates, piston 47 closes air passage 26, next piston 27 closes gas passage 44, and as volume of working chamber C1 diminishes air contained therein is being compressed. As volume of said working chamber C1 approaches its minimum, fuel is being injected into it (by its respective injector 1) and then self-ignited, and hot high-pressure gases are being produced. Next volume of working chamber C1 increases and hot high-pressure gases contained therein expand producing useful power.

Thus the engine scavenging system is very effective and features self-supercharging capabilities, separate scavenging pump is not needed, and effectiveness of the scavenging system increases as rotational speed rises.

The description above applies almost literally to the variant of the engine presented in FIGS. 23-29, and the only major difference is the shape of the spatial eccentric 3.

Thus this variant of the engine comprises four major parts: body 1, main rotor/oscillator 2, secondary rotor 3 and intermediate rotor 4. The body 1 (see FIGS. 23, 24, 26 and 27) is substantially spherical of shape. It is composed of two parts (hemispheres). Placed in body 1 there is a spherical chamber C, twelve injectors I corresponding to their respective engine's working chambers, suitable mechanisms MI (composed of rocking levers and pushing rods) driving said injectors, bearing 13 supporting the main rotor 2 and flat surface 14 supporting the secondary rotor 3. There is also a circular hot gas passage 15 placed in the engine body 1, said gas passage being equipped with exhaust port 16, and long air passage 17 with its air intake manifold 18 attached to the engine body 1.

The main rotor 2 (see FIGS. 23-27, and particularly 28) has main pin 21, spherical surface 23, flat surface 22, and central ring-shaped member 24. Main pin 21 pivots in the bearing 13 in the body 1, while the spherical surface 23 slides over the inner spherical surface of the cylinder C. The flat surface 22 of the shaft 2 support the intermediate rotor 4. There are six double-acting pistons 27 fastened to (or manufactured as a unique whole with) the main rotor's 2 flat surface 22 and central ring 24. There are also suitably phased cams (not shown) placed on the main pin 21. A main fresh air passage 25 cuts through the central ring 24; there are also disposed radially fresh air passages 26 in said central ring 24 placed between the pistons 27. The cams drive injectors I, thus separate camshaft is not needed. This relatively large number of pistons enables of decreasing piston's stroke without decreasing overall swept volume, thus minimizing the engine parts accelerations and mass forces, and improving engine's balance.

Intermediate rotor 4 (FIGS. 23-27, and particularly 29), has flat surface 41 supporting auxiliary rotor 3, spherical surface 43, and flat surface 42. There are also six double-acting pistons 47 fastened to the flat surface 42. There are also hot gas passages 44 placed in the body of the intermediate rotor 4 with their inlet openings 46 placed on the flat surface 42 and outlet openings 48 placed on the spherical surface 43. Fresh air passage 45 is formed in the central part of the body of intermediate rotor 4.

Secondary rotor 3 (FIGS. 23-27) has a flat surface 31 sliding over the flat surface 14 placed in the engine body, another flat surface 32 inclined relative the surface 31 at an angle dictated by the engine kinetics and sliding over the flat surface 41 placed on the intermediate eccentric 4, spherical surface 34, and a centrally placed air passage 33.

The description of the work of the previous variant of the engine applies literally in this case, and hence is omitted.

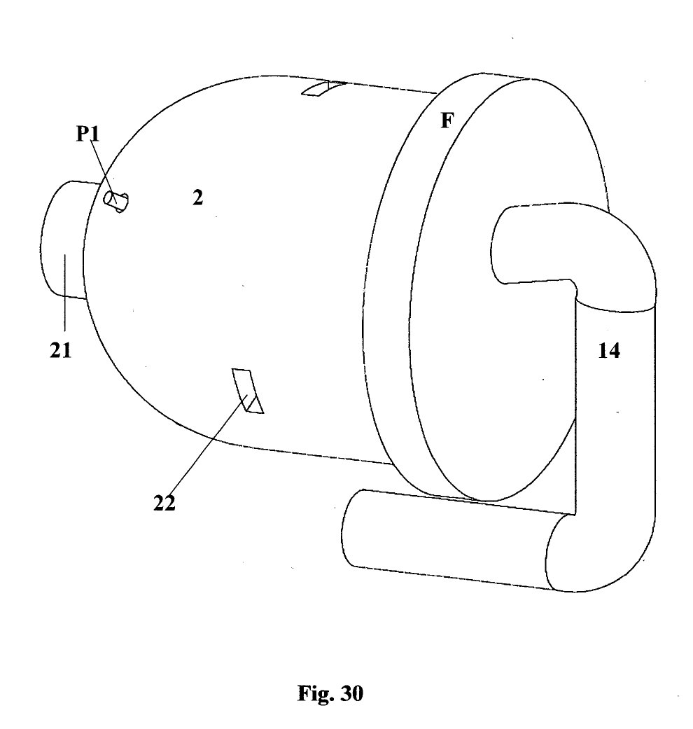

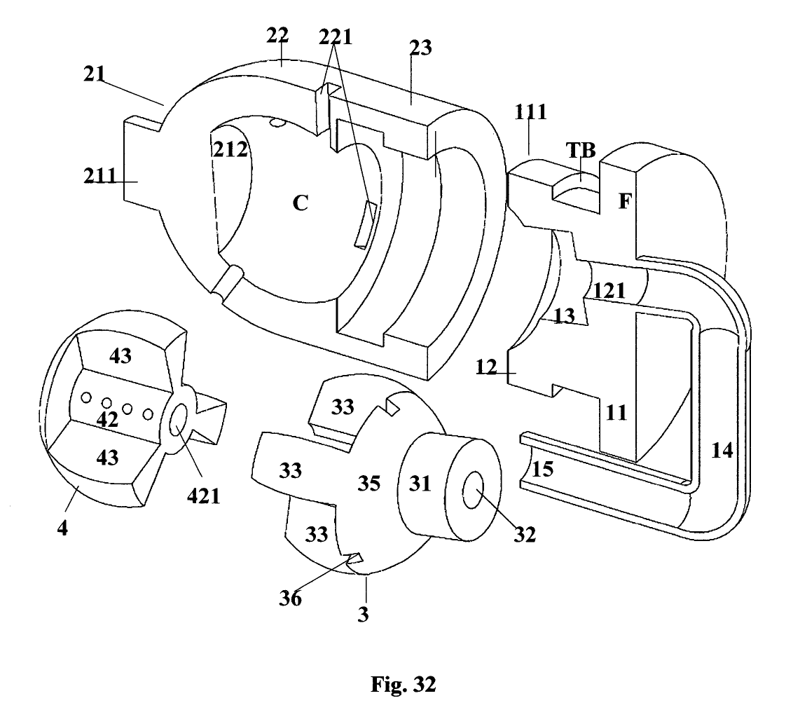

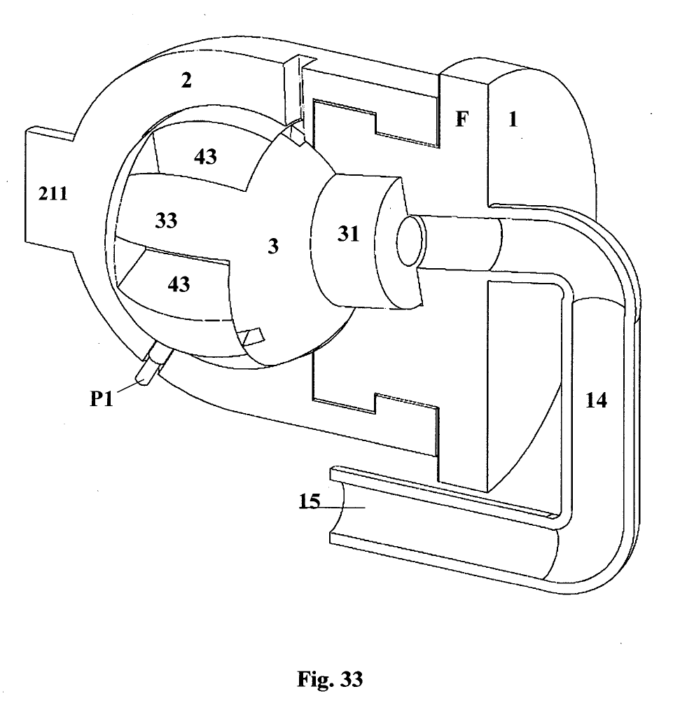

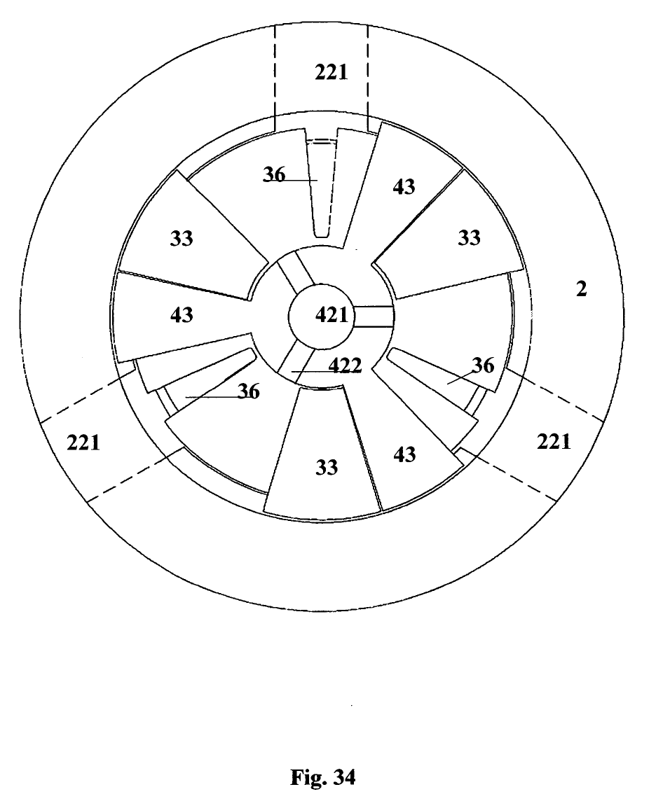

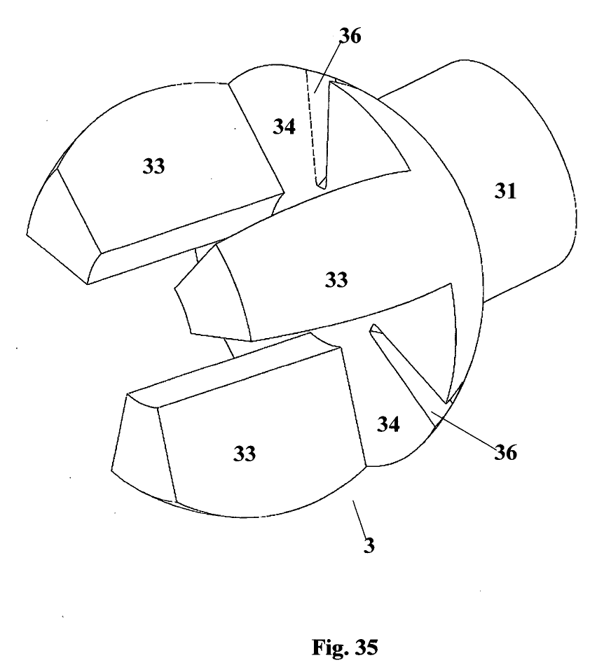

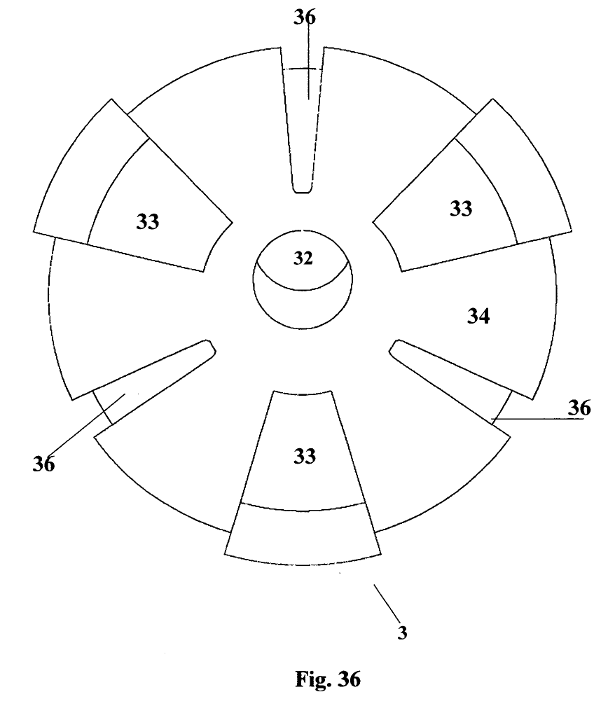

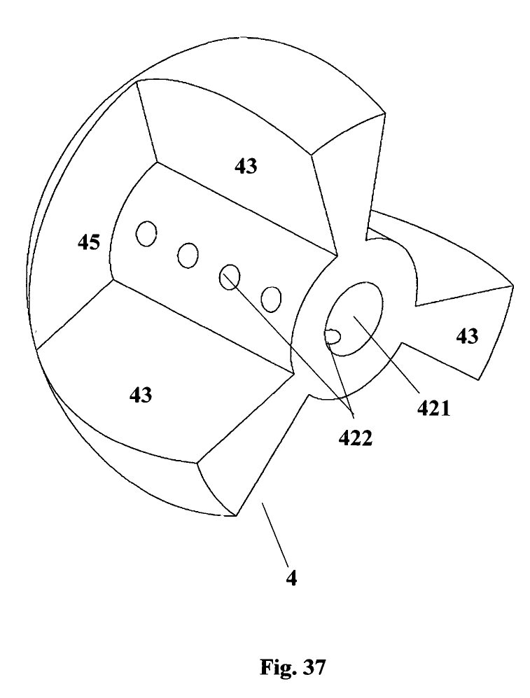

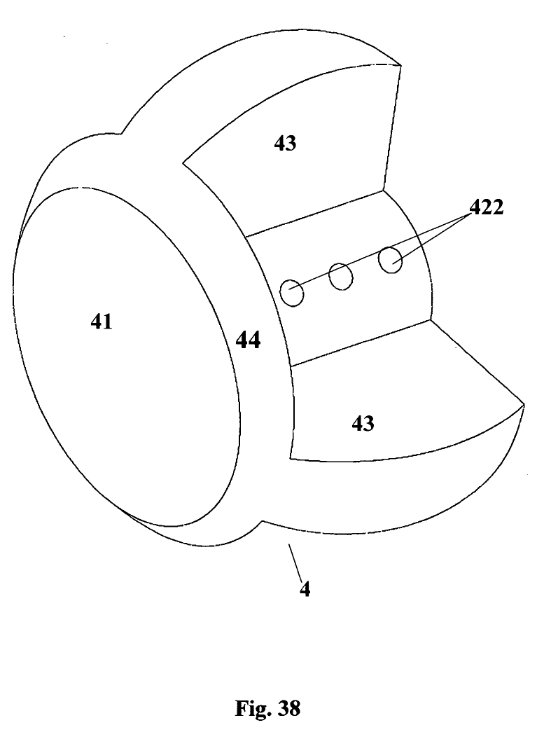

### 3. Rotary/Oscillating Spherical Engine III (FIGS. 30-38)

This is another variant of my spherical engine, intended to be a simple, inexpensive, exceptionally reliable and durable, very high power/weight ratio source of power, particularly for light aircraft (including light helicopters), UAVs, target drones, motor boats, small hovercrafts and sport motorcycles. It resembles the engine of Design 2, but would have improved swept volume/overall volume and thus power/volume and power/weight ratios thanks to differently shaped parts, and achieving these improvements is the main idea behind the Design. Again this is a two-stroke cycle engine with exceptionally effective self-sufficient (no separate scavenging pump) scavenging system, featuring self-supercharging capabilities, and the engine produces two power impulses per each revolution of its shaft.

Like the engine of Designs 1 and 2, this engine utilizes my spherical four-link mechanism. It comprises body 1, main rotor/shaft 2, secondary rotor 3, and intermediate rotor/eccentric 4. The rotors 2, 3 both pivot directly in the body 1. Intermediate eccentric 4 oscillates by certain angle <2π relative the secondary rotor 3, and executes complex rotary-nutating movement relative the body 1. All the axes of rotation of all the kinetic couples intersect at the center P of engine's spherical working chamber.

The body (see FIGS. 30-33) is composed of two parts: massive disc 11 with flange F, and body 12 of thrust bearing TB, both joined with the help of screws (not shown). Placed in body 1 there is bearing 111 and thrust bearing TB supporting engine's main rotor 2, bearing 13 supporting secondary rotor 3, air passage 121 placed in the part 11, and a portion of spherical working chamber C. There is also long air passage 14 with its air intake 15 attached to engine's body 1. This structure of the body is intended to enable assemble/disassemble of the thrust bearing TB. The engine is fastened to an aircraft with the help of flange F.

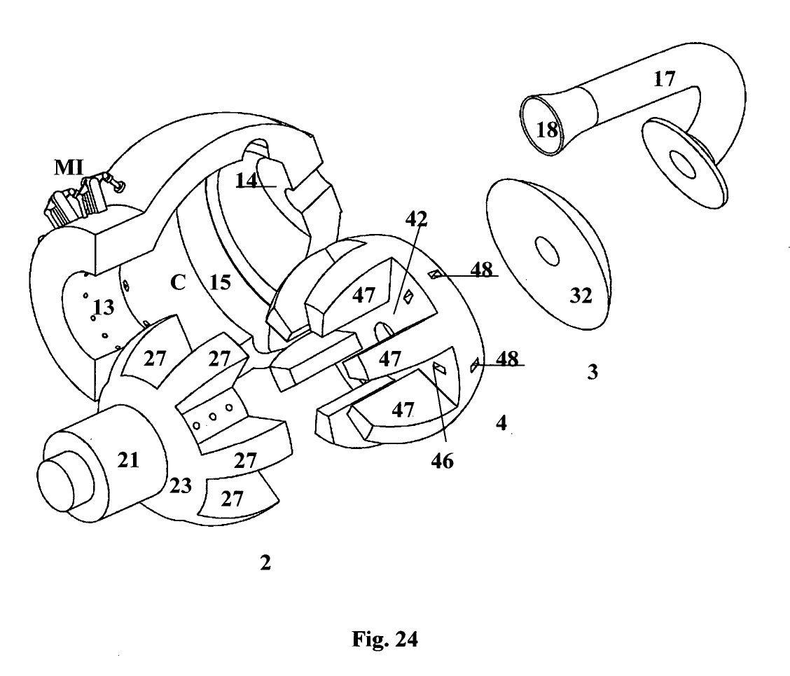

The main rotor 2 (FIGS. 24-26) is composed of three parts 21,22, and 23. Placed on part 21 of the main rotor 2 there is pin 211 (intended for fastening a propeller), flat surface 212 supporting intermediate rotor/eccentric 4 (and used to establish the required engine's kinetics), a portion of spherical working chamber C, and six ignition plugs P1. Placed in part 22 there are three exhaust ports 221. Part 23, together with part 12 of engine's body 1, form radial and thrust bearings 111, TB supporting main shaft 2.

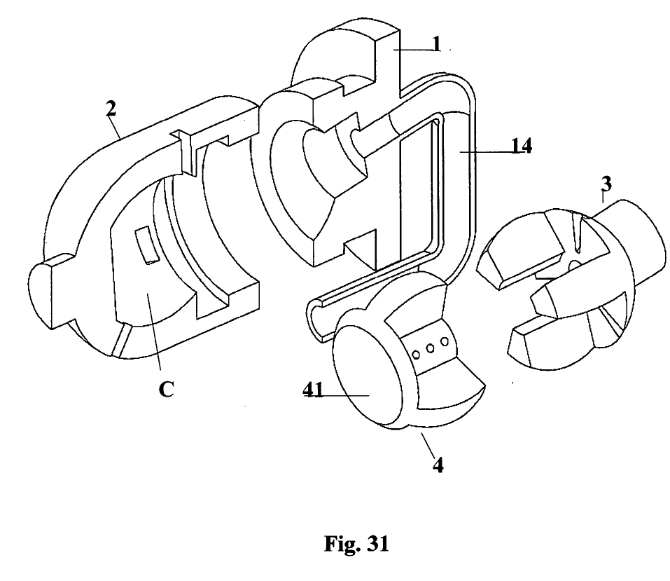

Intermediate rotor/eccentric 4 (FIGS. 31-33, and particularly 37 and 38), has a flat surface 41 sliding over flat surface 212 of main rotor 2, spherical surface 44 sliding over the spherical surface of the chamber C inside the main rotor 2, flat surface 45, over which the secondary rotor pistons slide, a central ring-shaped portion 42 with main air passage 421 and disposed radially secondary gas passages 422, and three double-acting pistons 43.

Secondary rotor 3 (FIGS. 31-33 and particularly 35 and 36) has main pin 31 projecting from its spherical portion 35 and pivoting in bearing 13, flat surface 34, over which the intermediate rotor pistons slide and inclined relative the pin 31 by an angle dictated by engine's kinetics, and three double-acting pistons 33 projecting from said flat surface 34. There is also an air passage 32 cutting through the pin 31 and spherical portion of the secondary rotor 3, and hot gas passages 36 formed in said flat surface 34.

Cooling system of the engine would be similar to that of the engine 2.

The ignition plugs are placed in a moving engine's element (rotor 2) therefore a suitable rotatable connection is needed to connect them with a source of electric current (not shown).

Now a brief description of the engine (in this instance an Otto-cycle two stroke engine) work follows. The engine has six varying-volume working chambers C1-C6 of precisely the same structure, bounded by engine's pistons 33 and 43 and spherical working chamber C. Fresh air enters the engine through the air intake manifold 15, and successively flows through air passages 14, 32, 421 and 422. As volume of a working chamber, say C1, approaches its maximum, intermediate eccentric piston 43 opens hot gas passage 36, and hot low-pressure gases contained in said working chamber C1 driven by centrifugal forces exit it through said gas passage 36, and exit the engine through exhaust manifold 22. A moment later auxiliary shaft piston 33 opens air passage 422, and fresh air driven by centrifugal forces enters working chamber C1. As engine's shaft 2 further rotates, piston 33 closes air passage 422, next piston 43 closes gas passage 36, and as volume of working chamber C1 diminishes air/fuel mixture contained therein is being compressed. As volume of said working chamber C1 approaches its minimum, air/fuel mixture is being ignited, and hot high-pressure gases are being produced. Next volume of working chamber C1 increases and hot high-pressure gases contained therein expand producing useful power and completing ordinary two-stroke Otto cycle.

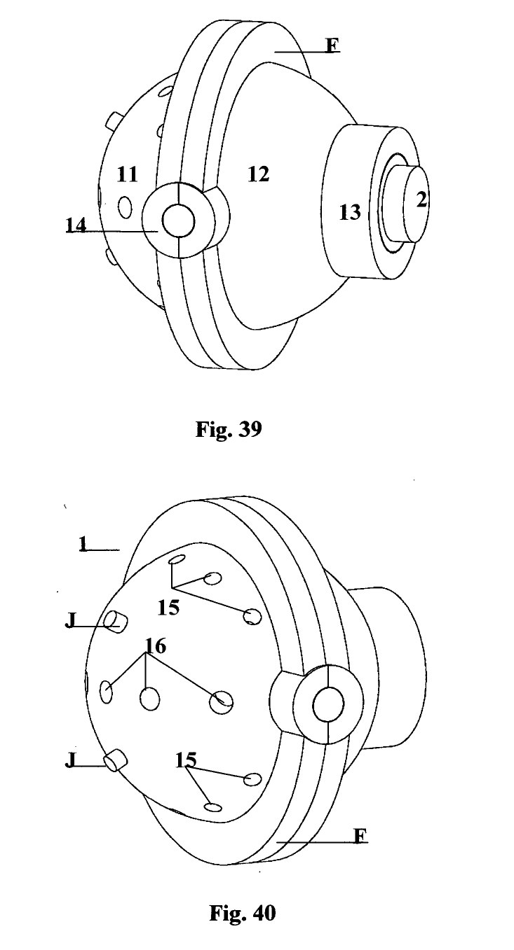

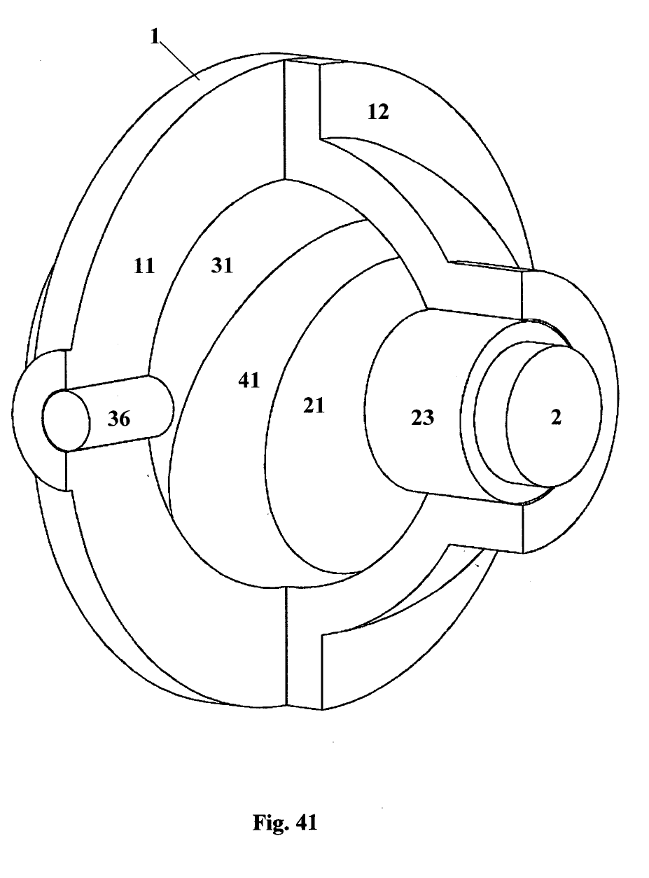

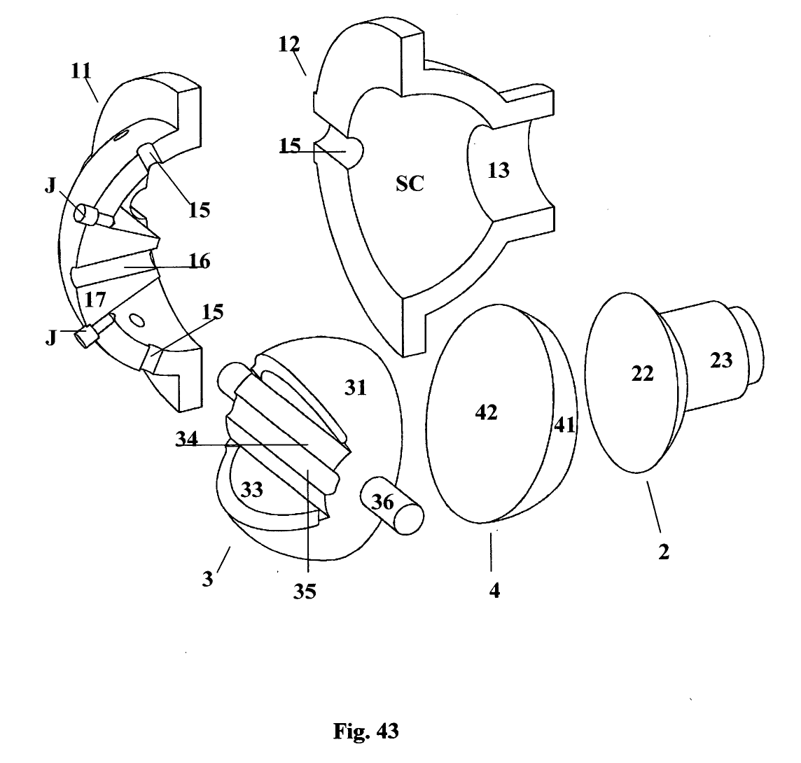

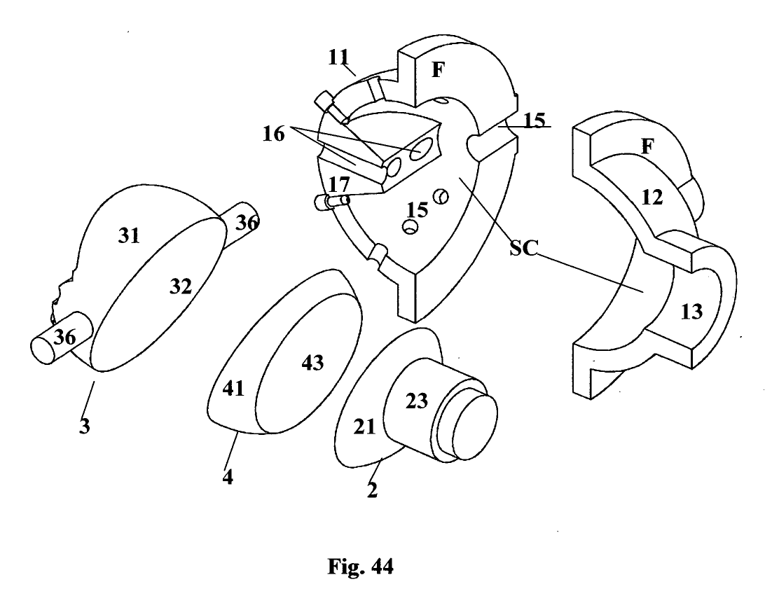

### 4. Oscillating Spherical Engine (FIGS. 39-45)

This is another preferred embodiment of the invention, namely 2-stroke oscillating spherical engine. This engine uses a variant of my spherical mechanism that produces rotary movement of one of its parts (“shaft”) from oscillating movement of other part (“oscillator”). The engine is assumed to work on the ordinary Diesel cycle.

Thus the engine comprises three moving elements: Oscillator 3, shaft 2 and intermediate eccentric 4 (which is a segment of a ball bounded by two planes) placed in engine's body 1. These four elements correspond to the four elements D, W, M and L of our spatial mechanism respectively. The peculiarity of this engine is that the axis VD of rotation of the element 3=D relative the body 1=L is perpendicular to the axis VW of rotation of the element 2=W relative the body 1=L.

Thanks to this choice of mechanism's geometry the engine produces rotary movement of the shaft 2 from the oscillating movement of the oscillator 3.

The body 1 (FIGS. 39-45) is formed from two halves 11, 12 in order to allow for assembling/disassembling of the engine. The two halves 11 and 12 are joined with the help of the flange F and screws (not shown). Placed in the body 1 there is a substantially spherical chamber SC accommodating the moving elements of the engine, flat surface FS used to establish the required kinetics of the engine, bearing 13 supporting the engine shaft, and bearings 14 supporting the oscillator; the axis of symmetry of the bearing 14 is perpendicular to the axis of symmetry of the bearing 13. There are also inlet ports 15 and outlet ports 16, and fuel injectors J. The body part 11 is equipped with a projection 17 cooperating with pistons formed in the engine's oscillator 3. The outlet ports 16 cut through the projection 17.

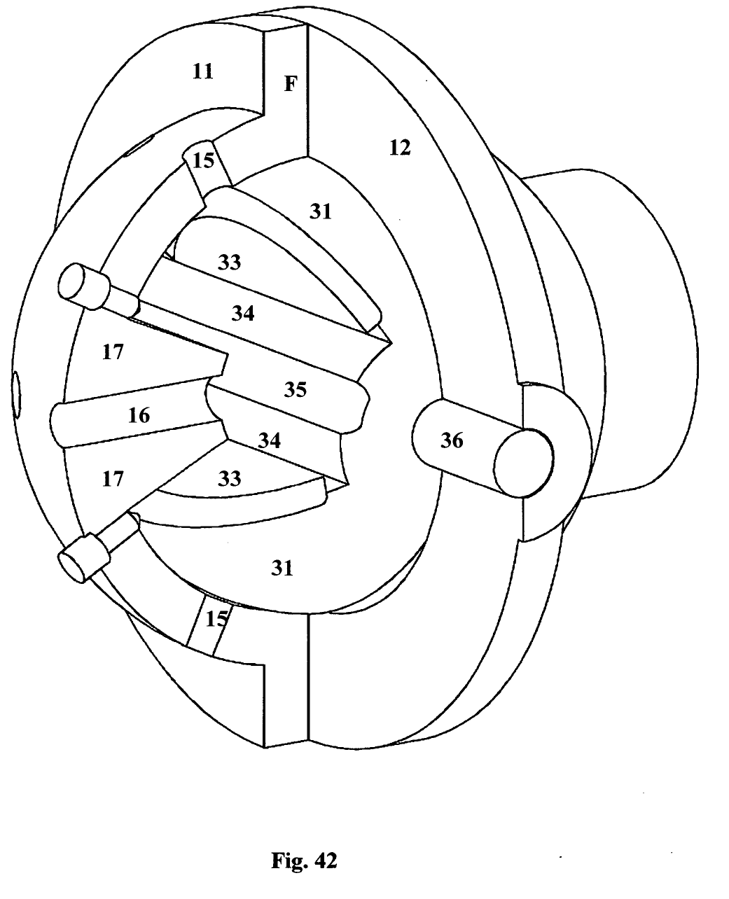

The oscillator 3 (FIGS. 41-45) has spherical surface 31, flat surface 32 and two pistons 33 separated by a cylindrical surface 34. Placed in the cylindrical surface 34 there is a gas passage 35. The oscillator is equipped with two pins 36. The oscillator is accommodated in the spherical chamber SC placed in the engine body, and the pins 36 are supported in the bearings 14.

The oscillator pistons 33 and the projection 17 form two combustion chambers C1 and C2.

The intermediate spatial eccentric 4 (FIGS. 41-45) has spherical surface 41 sliding over the surface of the spherical chamber SC, a flat surface 42 sliding over the flat surface 32 of the oscillator 3, and a flat surface 43 sliding over a flat surface of the shaft 2.

The shaft 2 (FIGS. 41-45) has a spherical surface 21, a flat surface 22 sliding over the flat surface 43 of the intermediate eccentric 4 and a pin 23 supported in the bearing 13.

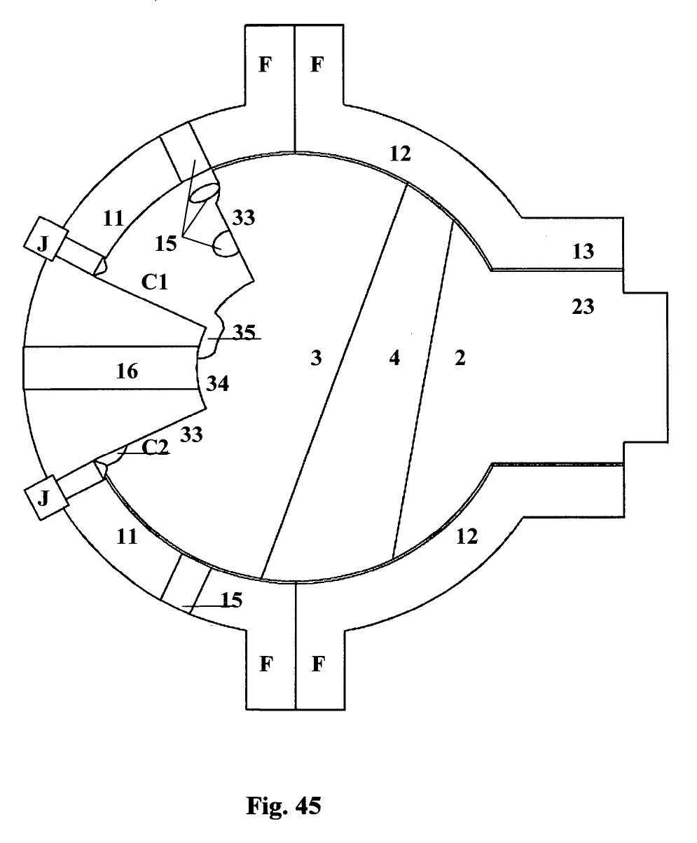

Now a brief description of the engine work follows (see FIG. 45). As the shaft 2 rotates the oscillator 3 oscillates opening and closing the inlet 15 and outlet 16 ports. As volume of one of the combustion chambers, e.g. the combustion chamber C1, approaches its maximum the gas passage 35 meets the outlet ports 16 and hot low-pressure gases exit the combustion chamber through said gas passage 35 and said outlet ports 16. As volume of the combustion chamber C1 still rises, the piston opens the inlet ports 15 and fresh air driven by a scavenging pump (not shown) enters the combustion chamber displacing the hot low-pressure gases. As the shaft 2 further rotates, the volume of the combustion chamber C1 diminishes and fresh air contained therein is compressed. Next the engine performs ordinary two-stroke cycle in each of its two combustion chambers. Thus the engine produces two power strokes per shaft revolution.

This engine requires a separate scavenging pump, but there is also a self-sufficient variant of the engine in which one of the pistons 33 does the work of the scavenging pump (and then the engine produces one power stroke per shaft revolution).

The foregoing description discloses four preferred embodiments of the invention. One skilled in the art will readily recognize from this description and from the accompanying figures and patent claims, that many changes and modifications can be made to the preferred embodiments without departing from the true spirit, scope and nature of the inventive concepts as defined in the following patent claims.

1. Spherical internal combustion rotary engine comprising a body, said body includes a substantially spherical chamber;
a main rotor with pistons attached thereto;
an intermediate rotor;
and a secondary rotor,
wherein all the rotors are placed inside the substantially spherical chamber in the body,
wherein the main rotor pivots in the body relative a first axis Vw, the secondary rotor pivots in the body relative another axis Vd, and the intermediate rotor rotates relative the main rotor around yet another axis Vmw and the intermediate rotor rotates relative the secondary rotor around yet another axis Wmd;
wherein at least the main rotor and the intermediate rotor assume the general form of spatial eccentric;
and the following relations between the engine geometric parameters hold:
a. the axis Vw of rotation of the main rotor relative the engine body is inclined relative the axis Vd of rotation of the secondary rotor relative the engine body by an angle l;
b. the axis Vmw of rotation of the intermediate rotor relative the main rotor is inclined relative the axis Vmd of rotation of the intermediate rotor relative the secondary rotor by an angle m;
c. the axis Vw of rotation of the main rotor relative the engine body is inclined relative the axis Vmw of rotation of the intermediate rotor relative the main rotor by an angle w;
d. the axis Vd of rotation of the secondary rotor relative the engine body is inclined relative the axis Vmd of rotation of the intermediate rotor relative the secondary rotor by an angle d;
and all the angles d, m, w are smaller than the right angle.

2. Spherical internal combustion rotary engine as defined in claim 1, wherein all the axes of rotation Vw, Vd, Vmw and Vmd intersect at a precisely one point.

3. Spherical internal combustion rotary engine according to claim 1, wherein w=d.

4. Spherical internal combustion rotary engine according to claim 1, wherein a number n of pistons (or fins) are attached to the main rotor and the same number of pistons (or fins) are attached to the intermediate rotor, wherein said pistons attached to said main rotor are placed between said pistons attached to said intermediate rotor so that 2 n combustion chambers are formed between said pistons.

5. Spherical internal combustion rotary engine according to claim 4, wherein air passages are placed in the engine body in proximity to the central part of said secondary rotor.

6. Spherical internal combustion rotary engine according to claim 5, wherein generally spiral gas collector encompassing said main rotor and the secondary rotor is placed in the engine body.

7. Spherical internal combustion rotary engine according to claim 6, wherein: an air passage is placed at the central part of said secondary rotor in constant communication with said air passages placed in the engine body; an air passage is placed at the central part of said intermediate rotor; and a primary air passage is placed in the central portion of said main rotor in communication with said air passage in the intermediate rotor; and secondary air passages are disposed radially in said central portion of the main rotor, wherein said secondary air passages have their inlet openings placed in said primary air passage placed in the central portion of the main rotor and their outlet openings placed between said pistons fastened to the main rotor.

8. Spherical internal combustion rotary engine according to claim 6, wherein: an air passage is placed at the central part of said secondary rotor in constant communication with said air passages placed in the engine body; and a primary air passage is placed in the central portion of said intermediate rotor in communication with said air passage in the secondary rotor; and secondary air passages are disposed radially in said central portion of the inter-mediate rotor, wherein said secondary air passages have their inlet openings placed in said primary air passage placed in the central portion of the intermediate rotor and their outlet openings placed between said pistons fastened to the intermediate rotor.

9. Spherical internal combustion rotary engine according to claim 1, characterized in that it is a Homogeneous Charge Compression Ignition (HCCI) engine.

10. Spherical internal combustion rotary engine according to claim 1, characterized in that it is a detonation engine.

11. Spherical internal combustion oscillating engine comprising a body, said body includes a substantially spherical chamber;
an oscillator with pistons attached thereto;
an intermediate rotor;
and a secondary rotor;
wherein the oscillator and the rotors are placed inside the substantially spherical chamber in the body; wherein the oscillator pivots in the body relative a first axis Vw, the secondary rotor pivots in the body relative another axis Vd, and the intermediate rotor rotates relative the oscillator around yet another axis Vmw and the intermediate rotor rotates relative the secondary rotor around yet another axis Wmd;
wherein at least the secondary rotor and the intermediate rotor assume the general form of spatial eccentric;
and the following relations between the engine geometric parameters hold:
a. the axis Vw of rotation of the oscillator relative the engine body is inclined relative the axis Vd of rotation of the secondary rotor relative the engine body by an angle l;
b. the axis Vmw of rotation of the intermediate rotor relative the oscillator is inclined relative the axis Vmd of rotation of the intermediate rotor relative the secondary rotor by an angle m;
c. the axis Vw of rotation of the oscillator relative the engine body is inclined relative the axis Vmw of rotation of the intermediate rotor relative the oscillator by an angle w;
d. the axis Vd of rotation of the secondary rotor relative the engine body is inclined relative the axis Vmd of rotation of the intermediate rotor relative the secondary rotor by an angle d;
the angle l equals 90 degrees and all the angles d, m, w are smaller than 90 degrees.

12. Spherical internal combustion oscillating engine as defined in claim 11, wherein all the axes of rotation Vw, Vd, Vmw and Vmd intersect at a precisely one point.

13. Spherical internal combustion oscillating engine according to claim 11, characterized in that it is a Homogeneous Charge Compression Ignition (HCCI) engine.

14. Spherical internal combustion oscillating engine according to claim 11, characterized in that it is a detonation engine.
